(19) United States
(12) Patent Application Publication
(10) Pub. No.: US 2022/0086911 A1
(43) Pub. Date: Mar. 17, 2022

(54) METHOD AND APPARATUS FOR SEMI-STATIC CHANNEL OCCUPANCY IN WIRELESS COMMUNICATION SYSTEM

(71) Applicant: Samsung Electronics Co., Ltd., Suwon-si (KR)

(72) Inventors: Jinyoung OH, Suwon-si (KR); Taehyoung KIM, Suwon-si (KR); Sungjin PARK, Suwon-si (KR); Hyoungju JI, Suwon-si (KR)

(21) Appl. No.: 17/476,370

(22) Filed: Sep. 15, 2021

(30) Foreign Application Priority Data
Sep. 16, 2020 (KR) 10-2020-0119178

(51) Int. Cl. H04W 74/08; H04W 74/00; H04W 72/04

(52) U.S. Cl. CPC H04W 74/0816; H04W 72/0453; H04W 72/0446; H04W 74/006

(57) ABSTRACT

The disclosure relates to a communication technique for combining an IoT technology with a 5G communication system for supporting a higher data transmission rate than that of a beyond-4G system, and a system therefor. The disclosure may be applied to intelligent services (for example, smart homes, smart buildings, smart cities, smart cars or connected cars, health care, digital education, retail businesses, security and safety related services, and the like) on the basis of 5G communication technologies and IoT-related technologies. The disclosure provides a method and apparatus for semi-static channel access of a terminal for uplink signal and/or channel transmission applied in an unlicensed band.

### CROSS-REFERENCE TO RELATED APPLICATION

This application is based on and claims priority under 35 U.S.C. § 119 to Korean Patent Application No. 10-2020-0119178, filed on Sep. 16, 2020, in the Korean Intellectual Property Office, the disclosure of which is herein incorporated by reference in its entirety.

### BACKGROUND

### 1. Field

The disclosure relates to a method and an apparatus for occupying a channel semi-statically in a wireless communication system.

### 2. Description of Related Art

To meet the demand for wireless data traffic having increased since deployment of 4th-generation (4G) communication systems, efforts have been made to develop an improved 5th-generation (5G) or pre-5G communication system. Therefore, the 5G or pre-5G communication system is also called a “beyond 4G network” or a “post long term evolution (LTE)/LTE-advanced (LTE-A) system (post LTE/LTE-A system)”.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (RAN) as the above-described big data processing technology may also be considered an example of convergence of the 5G technology with the IoT technology.

With the advance of mobile communication systems as described above, various services can be provided and wireless communication networks are becoming complex and diverse, and accordingly there is a need for ways to efficiently allocate downlink and uplink data channels.

The above information is presented as background information only to assist with an understanding of the disclosure. No determination has been made, and no assertion is made, as to whether any of the above might be applicable as prior art with regard to the disclosure.

### SUMMARY

The disclosure provides a method and an apparatus for semi-static channel occupancy of a terminal.

In accordance with an aspect of the present disclosure, a method performed by a terminal in a communication system is provided. The method includes: receiving, from a base station, configuration information on a semi-static channel occupancy performed by the terminal; performing a channel sensing on an unlicensed band for the semi-static channel occupancy; in case that the unlicensed band is idle, obtaining information indicating that a semi-static channel occupancy duration of the terminal is included in a semi-static channel occupancy duration of the base station; and transmitting and receiving, to and from the base station, signals based on the semi-static channel occupancy duration of the terminal and the semi-static channel occupancy duration of the base station.

In accordance with another aspect of the present disclosure, a method performed by a base station in a communication system is provided. The method includes: transmitting, to a terminal, configuration information on a semi-static channel occupancy performed by the terminal; transmitting, to the terminal, information indicating that a semi-static channel occupancy duration of the terminal is included in a semi-static channel occupancy duration of the base station; and transmitting and receiving, to and from the terminal, signals based on the semi-static channel occupancy duration of the terminal and the semi-static channel occupancy duration of the base station.

In accordance with another aspect of the present disclosure, a terminal in a communication system is provided. The terminal includes a transceiver; and a controller coupled with the transceiver and configured to: receive, from a base station, configuration information on a semi-static channel occupancy performed by the terminal, perform a channel sensing on an unlicensed band for the semi-static channel occupancy, in case that the unlicensed band is idle, obtain information indicating that a semi-static channel occupancy duration of the terminal is included in a semi-static channel occupancy duration of the base station, and transmit and receive, to and from the base station, signals based on the semi-static channel occupancy duration of the terminal and the semi-static channel occupancy duration of the base station.

In accordance with another aspect of the present disclosure, a base station in a communication system is provided. The base station includes a transceiver; and a controller coupled with the transceiver and configured to: transmit, to a terminal, configuration information on a semi-static channel occupancy performed by the terminal, transmit, to the terminal, information indicating that a semi-static channel occupancy duration of the terminal is included in a semi-static channel occupancy duration of the base station, and transmit and receiving, to and from the terminal, signals based on the semi-static channel occupancy duration of the terminal and the semi-static channel occupancy duration of the base station.

According to the disclosure, a terminal may efficiently perform semi-static channel occupancy and signal transmission/reception.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication system according to an embodiment of the disclosure;

FIG. 2 illustrates a configuration of a base station in a wireless communication system according to various embodiments of the present disclosure;

FIG. 3 illustrates a configuration of a terminal in a wireless communication system according to various embodiments of the present disclosure;

FIG. 4 illustrates a configuration of a communication interface in a wireless communication system according to various embodiments of the present disclosure;

FIG. 5 illustrates a frame, a subframe, and a slot structure of a 5G communication system;

FIG. 6 illustrates a basic structure of a time-frequency domain of a 5G communication system;

FIG. 7 illustrates an example of configuration a bandwidth part and an intra-cell guard band of a 5G communication system;

FIG. 8 illustrates an example of configuration a control resource set of a downlink control channel of a 5G communication system;

FIG. 9 illustrates the structure of a downlink control channel of a 5G communication system;

FIG. 10 illustrates an example of UL-DL configuration in a 5G communication system;

FIG. 11 illustrates an example of a channel access procedure for semi-static channel occupancy in a wireless communication system according to various embodiments of the present disclosure;

FIG. 12 illustrates an example of a channel access procedure for dynamic channel occupancy in a wireless communication system according to various embodiments of the present disclosure;

FIG. 13 illustrates an example of a configuration for semi-static channel occupancy of a terminal in a wireless communication system according to various embodiments of the present disclosure;

FIG. 14 illustrates an example of a method for semi-static channel occupancy of a terminal in a wireless communication system according to various embodiments of the present disclosure;

FIG. 15 illustrates an example of an operation of a terminal according to various embodiments of the present disclosure; and

FIG. 16 illustrates an example of an operation of a base station according to various embodiments of the present disclosure.

### DETAILED DESCRIPTION

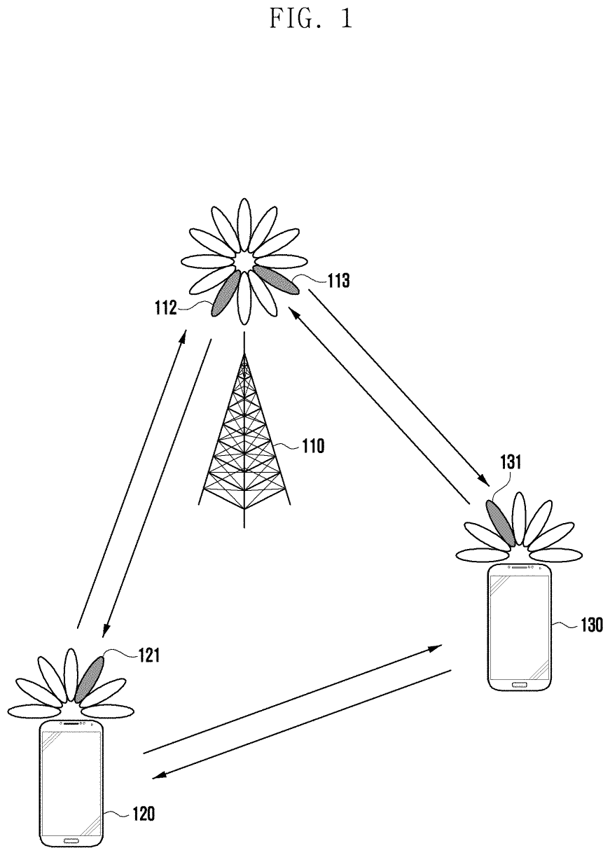

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in the following description of the disclosure, a detailed description of known functions or configurations incorporated herein will be omitted when it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, a base station is a subject configured to perform resource allocation to a terminal, and may be one of a gNode B, an eNode B, a Node B, (or xNode B (here, x is a character including “g” and “e”)), a wireless access unit, a base station controller, a satellite, an air-born vehicle, or a node on a network. A terminal (user equipment (UE)) may include a mobile station (MS), a vehicle, a satellite, an air-born vehicle, a cellular phone, a smartphone, a computer, or a multimedia system capable of a communication function. In the disclosure, downlink (DL) denotes a wireless transmission path of a signal transmitted by a base station to a terminal, and uplink (UL) denotes a wireless transmission path of a signal transmitted by a terminal to a base station. Additionally, a sidelink (SL), which denotes a wireless transmission path of a signal transmitted by a terminal to another terminal, may exist.

In addition, hereinafter, although a LTE, a LTE-A, or a 5G system may be described as an example, but an embodiment of the disclosure may be also applied to other communication systems having a similar technical background or channel type. For example, the other communication systems may include a 5G-advance, NR-advance, or 6^{th} generation mobile communication technology (6G) developed after 5G mobile communication technology (or new radio, NR), and 5G described below may be a concept including a conventional LTE and LTE-A and other services similar thereto. In addition, the disclosure may be also applied to another communication system through partial modification without departing too far from the scope of the disclosure according to the determination of a person those skilled in the art.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, the “unit” in the embodiments may include one or more processors.

Wireless communication systems have been developed from wireless communication systems providing voice centered services to broadband wireless communication systems providing high-speed, high-quality packet data services, such as communication standard specifications of high speed packet access (HSPA), long term evolution (LTE or evolved universal terrestrial radio access (E-UTRA)), LTE-advanced (LTE-A), and LTE-Pro of the 3GPP, high rate packet data (HRPD) and ultra mobile broadband (UMB) of 3GPP2, and 802.16e of IEEE.

An LTE system that is a representative example of the broadband wireless communication system has adopted an orthogonal frequency division multiplexing (OFDM) scheme in a downlink (DL) and has adopted a single carrier frequency division multiple access (SC-FDMA) scheme in an uplink (UL). The UL refers to a wireless link through which a terminal transmits data or a control signal to a base station, and the DL refers to a wireless link through which a base station transmits data or a control signal to a terminal. The multiple access scheme as described above normally allocates and operates time-frequency resources including data or control information to be transmitted according to each user so as to prevent the time-frequency resources from overlapping with each other, that is, to establish orthogonality for distinguishing the data or the control information of each user.

As a future communication system after the LTE system, a 5G communication system has to be able to freely reflect various requirements of a user and a service provider, and thus services satisfying various requirements at the same time need to be supported. The services considered for the 5G communication system include enhanced mobile broadband (eMBB), massive machine-type communication (mMTC), ultra-reliability low latency communication (URLLC), and the like.

eMBB aims to provide a higher data transmission rate than a data transmission rate supported by the LTE, LTE-A, or LTE-Pro. For example, in the 5G communication system, eMBB may be able to provide a peak data rate of 20 Gbps in the DL and a peak data rate of 10 Gbps in the UL from the viewpoint of one base station. In addition, the 5G communication system may provide the increased user perceived data rate of the terminal simultaneously with providing the peak data rate. In order to satisfy such requirements, improvement of various transmitting/receiving technologies including a further improved multi input multi output (MIMO) transmission technology is needed. In addition, signals are transmitted using a transmission bandwidth of up to 20 MHz in a 2 GHz band used by the LTE, but the 5G communication system uses a bandwidth wider than 20 MHz in a frequency band of 3 to 6 GHz or more than 6 GHz, thereby satisfying a data transmission rate required in the 5G communication system.

mMTC is being considered to support application services such as Internet of Thing (IoT) in the 5G communication system. mMTC is required for an access support of a large-scale terminal in a cell, coverage enhancement of a terminal, improved battery time, and cost reduction of a terminal in order to efficiently provide the IoT. The IoT needs to be able to support a large number of terminals (e.g., 1,000,000 terminals/km′) in a cell because it is attached to various sensors and devices to provide communication functions. In addition, because the terminals supporting mMTC are more likely to be positioned in shaded areas not covered by a cell, such as an underground of a building due to nature of services, the terminals require a wider coverage than other services provided by the 5G communication system. The terminals that support mMTC may be configured as inexpensive terminals and require very long battery lifetime, such as 10 to 15 years, because it is difficult to frequently replace batteries of the terminals.

URLLC is a cellular-based wireless communication service used for mission-critical purposes. For example, URLLC may be used in remote control for robots or machinery, industrial automation, unmanned aerial vehicles, remote health care, or emergency alerts. Accordingly, communication provided by URLLC may provide very low latency and very high reliability. For example, URLLC-supportive services need to meet an air interface latency of less than 0.5 milliseconds and simultaneously include requirements of a packet error rate of 10⁻⁵ or less. Accordingly, for URLLC-supportive services, the 5G system may be required to provide a transmit time interval (TTI) shorter than those for other services while securing reliable communication links by allocating a broad resource in a frequency band.

The three services, i.e., eMBB, URLLC, and mMTC, considered in the above 5G communication system may be multiplexed in one system and may be transmitted. Here, the services may use different transmission/reception techniques and transmission/reception parameters in order to satisfy different requirements. However, 5G is not limited to the above three services.

FIG. 1 illustrates a wireless communication system according to various embodiments of the present disclosure. FIG. 1 illustrates a base station 110, a terminal 120, and a terminal 130, as a part of nodes using a wireless channel in a wireless communication system. FIG. 1 illustrates only one base station, but may further include another base station that is identical or similar to the base station 110.

Referring to FIG. 1, the base station 110 may be a network infrastructure that provides the terminals 120 and 130 with wireless access. The base station 110 has a coverage defined by a predetermined geographic area based on the arrival distance over which a wireless signal may be transmitted. The base station 110 may be referred to as an “access point (AP),” an “eNodeB (eNB),” a “5th generation node (5G node),” a “wireless point,” a “transmission/reception point (TRP),” or other terms having an equivalent technical meaning.

Each of the terminal 120 and the terminal 130 is an apparatus used by a user, and performs communication with the base station 110 through a wireless channel. In some cases, at least one of the terminal 120 and the terminal 130 may be operated without user involvement. That is, at least one of the terminal 120 and the terminal 130 is an apparatus that performs machine-type communication (MTC), and may not be carried by a user. Each of the terminal 120 and the terminal 130 may be referred to as a “mobile station,” a “subscriber station,” a “remote terminal,” a “wireless terminal,” a “user device,” a station (STA), or other terms having an equivalent technical meaning.

The wireless communication environment may include wireless communication in an unlicensed band as well as a licensed band. The base station 110, the terminal 120, and the terminal 130 may transmit or receive radio signals in an unlicensed band (e.g., 5 GHz to 7.125 GHz band, or 71 GHz band or less). As an embodiment, in the unlicensed band, a cellular communication system and another communication system (e.g., a wireless local area network, WLAN) may coexist. In order to ensure fairness between two communication systems, that is, to prevent a situation in which a channel is used exclusively by one system, the base station 110, the terminal 120, and the terminal 130 may perform a channel access procedure for the unlicensed band. As an example of the channel access procedure for the unlicensed band, the base station 110, the terminal 120, and the terminal 130 may perform listen-before talk (LBT).

The base station 110, the terminal 120, and the terminal 130 may transmit or receive radio signals in a millimeter wave (mmWave) band (28 GHz, 30 GHz, 38 GHz, or 60 GHz). Here, in order to improve a channel gain, the base station 110, the terminal 120, and the terminal 130 may perform beamforming. Here, the beamforming may include transmission beamforming and reception beamforming. That is, the base station 110, the terminal 120, and the terminal 130 may assign directivity to a transmission signal or a reception signal. To this end, the base station 110 and the terminals 120 and 130 may select serving beams through a beam search or a beam management procedure. After the serving beams are selected, subsequent communication may be performed through a resource in a quasi-co-located (QCL) relationship with a resource for transmission of the serving beams.

The base station 110 may select a beam 112 or 113 in a specific direction. Further, the base station 110 may perform communication with the terminal by using the beam 112 or 113 in a specific direction. For example, the base station 110 may receive a signal from the terminal 120 or transmit a signal to the terminal 120 by using the beam 112. In addition, the terminal 120 may receive a signal from the base station 110 or transmit a signal to the base station 110 by using the beam 121. In addition, the base station 110 may receive a signal from the terminal 130 or transmit a signal to the terminal 130 by using the beam 113. In addition, the terminal 130 may receive a signal from the base station 110 or transmit a signal to the base station 110 by using the beam 131.

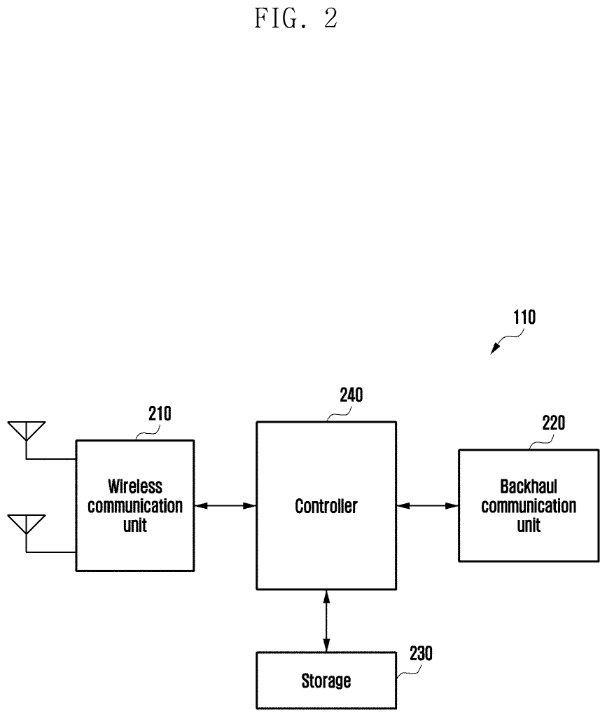

FIG. 2 illustrates a configuration of a base station in a wireless communication system according to various embodiments of the present disclosure.

The configuration illustrated in FIG. 2 may be understood as a configuration of the base station 110 of FIG. 1. The terms “unit,” “device”, etc. used below refer to a unit for processing at least one function or operation, and may be implemented as hardware, software, or a combination of hardware and software.

Referring to FIG. 2, the base station may include a wireless communication unit 210, a backhaul communication unit 220, a storage 230, and a controller 240.

The wireless communication unit 210 (that can be interchangeably used with a transceiver) may perform functions for transmitting or receiving a signal through a wireless channel. For example, the wireless communication unit 210 may perform conversion between a baseband signal and a bit string according to the physical layer standard specification of a system. For example, in case of signal transmission, the wireless communication unit 210 may generate complex symbols by encoding and modulating a transmission bit string. Further, in case of signal reception, the wireless communication unit 210 may restore a reception bit string by demodulating and decoding a received baseband signal.

In addition, the wireless communication unit 210 may up-convert a baseband signal to a radio frequency (RF) band signal, transmit the up-converted signal through an antenna, and down-convert an RF band signal received through the antenna to a baseband signal. To this end, the wireless communication unit 210 may include a transmission filter, a reception filter, an amplifier, a mixer, an oscillator, a digital to analog converter (DAC), an analog to digital converter (ADC), and the like. In addition, the wireless communication unit 210 may include multiple RF chains corresponding to multiple transmission/reception paths. Further, the wireless communication unit 210 may include at least one antenna array including multiple antenna elements.

In terms of hardware, the wireless communication unit 210 may include a digital unit and an analog unit, and the analog unit may include multiple sub-units according to an operation power, an operation frequency, and the like. The digital unit may be implemented by at least one processor (e.g., a digital signal processor (DSP)).

As described above, the wireless communication unit 210 may transmit or receive a signal. Accordingly, all or a part of the wireless communication unit 210 may be referred to as a “transmitter,” a “receiver,” or a “transceiver,” In addition, in the following description, the transmission and reception performed through a wireless channel may be understood as the above-described processing being performed by the wireless communication unit 210. According to various embodiments, the wireless communication unit 210 may include at least one transceiver.

The backhaul communication unit 220 may provide an interface for performing communication with other nodes within a network. That is, the backhaul communication unit 220 may convert a bit string transmitted from the base station to another node, for example, another access node, another base station, an upper node, a core network, etc., into a physical signal, and may convert a physical signal received from another node into a bit string.

The storage 230 may store data, such as a basic program for operation of the base station, an application program, and configuration information. The storage 230 may include a volatile memory, a nonvolatile memory, or a combination of a volatile memory and a nonvolatile memory. Further, the storage 230 provides stored data in response to a request from the controller 240. In an embodiment, the storage 230 may include at least one memory.

The controller 240 controls the overall operation of the base station. For example, the controller 240 transmits or receives a signal through the wireless communication unit 210 or the backhaul communication unit 220. In addition, the controller 240 records data in the storage 230 and reads the data. Further, the controller 240 may perform functions of a protocol stack required by the communication standard specification. In an embodiment, the protocol stack may be included in the wireless communication unit 210. In an embodiment, the controller 240 may include at least one processor.

The controller 240 may control the base station to perform operations according to various embodiments described below. For example, the controller 240 may perform a channel access procedure for an unlicensed band. The transceiver (for example, the wireless communication unit 210) may receive signals transmitted in an unlicensed band, and the controller 240 may compare the strength of the received signal with a threshold value determined according to a function value that is predefined or has a bandwidth as a factor, to determine whether the unlicensed band is in an idle state. Further, for example, the controller 240 may transmit a control signal to the terminal or receive a control signal from the terminal through the transceiver. In addition, the controller 240 may transmit data to the terminal or receive data from the terminal through the transceiver. The controller 240 may determine the result of transmission of a signal transmitted to the terminal based on the control signal or data signal received from the terminal. The controller 240 may configure one pieces of downlink control information (DCI) for allocation of one or more data channels to one or more cells, and may transmit the DCI to the terminal through the wireless communication unit 210. Further, before transmission of the DCI, the controller 240 may provide configuration information required for allocation of one or more data channels using one DCI to the terminal via higher layer signaling. Furthermore, the controller 240 may transmit a data channel to the terminal or receive a data channel from the terminal based on the configuration information and information fields included in the DCI.

In addition, for example, the controller 240 may perform management or change of the length of a contention window (CW) (hereinafter, referred to as contention window adjustment) for the channel access procedure based on a transmission result, i.e., based on a result of reception of the control signal or the data signal by the terminal. According to an embodiment, the controller 240 may determine a reference duration in order to obtain the transmission result for contention window adjustment. The controller 240 may determine a data channel for contention window adjustment in the reference duration. The controller 240 may determine a reference control channel for contention window adjustment in the reference duration. If it is determined that the unlicensed band is in the idle state, the controller 240 may occupy the channel.

In addition, the controller 240 may receive uplink control information (UCI) from the terminal through the wireless communication unit 210, and may perform control to identify, through at least one hybrid automatic repeat request acknowledgment (HARQ-ACK) included in the uplink control information above and/or channel state information (CSI), whether retransmission for the downlink data channel is required and/or whether modulation and coding method change is required. In addition, the controller 240 may perform control to generate downlink control information for scheduling of initial or retransmission of downlink data or requesting transmission of uplink control information, and to transmit the above downlink control information to the terminal through the wireless communication unit 210. In addition, the controller 240 may control the wireless communication unit 210 to receive (re)transmitted uplink data and/or uplink control information according to the downlink control information above.

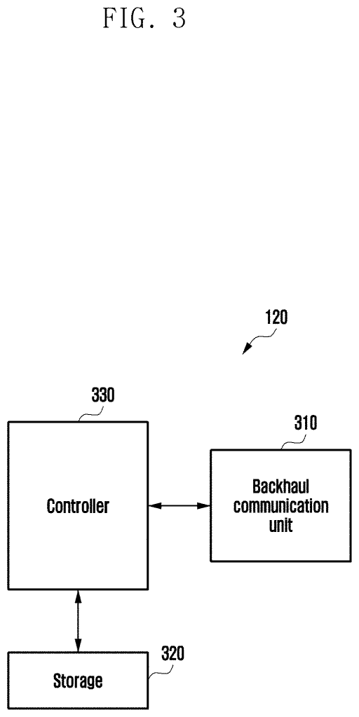

FIG. 3 illustrates a configuration of a terminal in a wireless communication system according to various embodiments of the present disclosure.

The configuration illustrated in FIG. 3 may be understood as a configuration of the terminal 120 or 130 of FIG. 1. The terms “unit,” “device,” etc. used below refer to a unit for processing at least one function or operation, and may be implemented as hardware, software, or a combination of hardware and software.

Referring to FIG. 3, the terminal includes a wireless communication unit 310, a storage 320, and a controller 330.

The wireless communication unit 310 (hereinafter, interchangeably used with a transceiver) may perform functions for transmitting or receiving a signal through a wireless channel. For example, the wireless communication unit 310 may perform conversion between a baseband signal and a bit string according to the physical layer standard specification of a system. For example, in case of signal transmission, the wireless communication unit 310 may generate complex symbols by encoding and modulating a transmission bit string. Further, in case of signal reception, the wireless communication unit 310 may restore a reception bit string by demodulating and decoding a received baseband signal. In addition, the wireless communication unit 310 may up-convert a baseband signal to an RF band signal, transmit the up-converted signal through an antenna, and down-convert an RF band signal received through the antenna to a baseband signal. For example, the wireless communication unit 310 may include a transmission filter, a reception filter, an amplifier, a mixer, an oscillator, a DAC, an ADC, and the like.

In addition, the wireless communication unit 310 may include multiple transmission/reception paths. Further, the wireless communication unit 310 may include at least one antenna array including multiple antenna elements. In terms of hardware, the wireless communication unit 310 may include a digital unit and an analog unit (e.g., a radio frequency integrated circuit (RFIC)). Here, the digital unit and the analog unit may be implemented as a single package. In addition, the wireless communication unit 310 may include multiple RF chains. Furthermore, the wireless communication unit 310 may include at least one antenna array including multiple antenna elements to perform beamforming.

As described above, the wireless communication unit 310 may transmit or receive a signal. Accordingly, all or a part of the wireless communication unit 310 may be referred to as a “transmitter,” a “receiver,” or a “transceiver,” In addition, in the following description, the transmission and reception performed through a wireless channel may be understood as the above-described processing being performed by the wireless communication unit 310. According to an embodiment, the wireless communication unit 310 may include at least one transceiver.

The storage 320 stores data, such as a basic program for operation of the terminal, an application program, and configuration information. The storage 320 may include a volatile memory, a nonvolatile memory, or a combination of a volatile memory and a nonvolatile memory. Further, the storage 320 provides stored data in response to a request from the controller 330. According to an embodiment, the storage 320 may include at least one memory.

The controller 330 controls the overall operation of the terminal. For example, the controller 330 transmits or receives a signal through the wireless communication unit 310. In addition, the controller 330 records data in the storage 320 and reads the data. Further, the controller 330 may perform functions of a protocol stack required by the communication standard specification. To this end, the controller 330 may include at least one processor or a microprocessor, or may be part of a processor. According to an embodiment, the controller 330 may include at least one processor. Further, according to an embodiment, the controller 330 and a part of the wireless communication unit 310 may be referred to as a communication processor (CP).

The controller 330 may control the terminal to perform operations according to at least one of various embodiments to be described later. For example, the controller 330 may receive a downlink signal (downlink control signal or downlink data) transmitted by the base station through the transceiver (e.g., the communication unit 310). Further, for example, the controller 330 may determine a transmission result for a downlink signal. The transmission result may include feedback information such as an acknowledgement (ACK), a negative ACK (NACK), or discontinuous transmission (DTX) of the transmitted downlink signal. In the disclosure, the transmission result may also be referred to as various terms such as a downlink signal reception state, a reception result, a decoding result, HARQ-ACK information, and the like. Further, for example, the controller 330 may transmit an uplink signal to the base station through the transceiver, as a signal in response to the downlink signal. The uplink signal may explicitly or implicitly include the result of transmission of the downlink signal. In addition, for example, the controller 330 may include, in the uplink control information, one or more pieces of information among the above-described HARQ-ACK information and/or channel state information (CSI), and may transmit the uplink control information to the base station through the wireless communication unit 310. Here, the uplink control information may be transmitted together with the uplink data through the uplink data channel, or may be transmitted without the uplink data to the base station through the uplink data channel.

The controller 330 may perform a channel access procedure with regard to an unlicensed band. For example, the wireless communication unit 310 receives signals transmitted in an unlicensed band, and the controller 330 may compare the strength of the received signal with a threshold value determined according to a function value that is predefined or has a bandwidth as a factor, to determine whether the unlicensed band is in an idle state. The controller 330 may perform an access procedure with regard to the unlicensed band in order to transmit a signal to the base station. In addition, the controller 330 may determine an uplink transmission resource for transmission of uplink control information by using at least one of a result of performing the above-described channel access procedure and downlink control information received from the base station, and may transmit uplink control information to the base station through the transceiver.

The controller 330 may receive, from the base station through the wireless communication unit 310, higher layer signaling including configuration information required for reception of one piece of downlink control information (DCI) configured to allocate one or more data channels to one or more cells. The controller 330 may also receive the DCI based on the configuration information and interpret fields included in the DCI. Further, the controller 330 may transmit a data channel to or receive a data channel from the base station based on the configuration information and information fields included in the DCI.

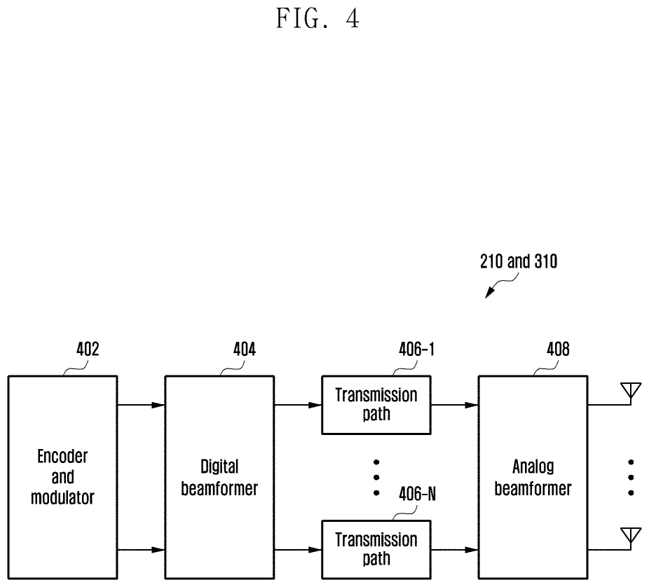

FIG. 4 illustrates a configuration of a communication unit in a wireless communication system according to various embodiments of the present disclosure. FIG. 4 illustrates an example of a detailed configuration of the wireless communication unit 210 of FIG. 2 or the communication unit 310 of FIG. 3. Specifically, FIG. 4 is a part of the wireless communication unit 210 of FIG. 2 or the wireless communication unit 310 of FIG. 3, and may illustrate elements performing beamforming.

Referring to FIG. 4, the wireless communication unit 210 or the communication unit 310 may include an encoder and modulator 402, a digital beamformer 404, multiple transmission paths 406-1 to 406-N, and an analog beamformer 408.

The encoder and modulator 402 performs channel encoding. For the channel encoding, at least one of a low-density parity check (LDPC) code, a convolutional code, and a polar code may be used. The encoder and modulator 402 may generate modulation symbols by performing constellation mapping on the coded bits.

The digital beamformer 404 performs beamforming for digital signals (e.g., modulation symbols). To this end, the digital beamformer 404 may multiply the modulation symbols by beamforming weight values. Here, the beamforming weight values may be used for changing the size and phase of the signal, and may be referred to as a “precoding matrix” or a “precoder.” The digital beamformer 404 may output the digitally beamformed (that is, precoded) modulation symbols to the multiple transmission paths 406-1 to 406-N. Here, according to a MIMO transmission scheme, the modulation symbols may be multiplexed, or the same modulation symbols may be provided through the multiple transmission paths 406-1 to 406-N.

The multiple transmission paths 406-1 to 406-N may convert the digitally beamformed digital signals into analog signals. To this end, each of the multiple transmission paths 406-1 to 406-N may include an inverse fast Fourier transform (IFFT) calculation unit, a cyclic prefix (CP) insertion unit, a digital-to-analog converter (DAC), and an up-conversion unit. The CP insertion unit is for an orthogonal frequency division multiplexing (OFDM) scheme, and may be omitted when another physical-layer scheme (e.g., a filter bank multi-carrier (FBMC)) is applied. That is, the multiple transmission paths 406-1 to 406-N may provide independent signal-processing processes for multiple streams generated through the digital beamforming. According to the implementation scheme, some of the elements of the multiple transmission paths 406-1 to 406-N may be used in common.

The analog beamformer 408 may perform beamforming on analog signals from the multiple transmission paths 406-1 to 406-N and connect the transmission paths to at least one antenna array including multiple antenna elements. To this end, the analog beamformer 408 may multiply analog signals by beamforming weight values. The beamformed weight values may be used to change the size and phase of the signal. The analog beamformer 408 may be variously configured according to the connection structure between the multiple transmission paths 406-1 to 406-N and antennas. For example, each of the multiple transmission paths 406-1 to 406-N may be connected to a different antenna array. In another example, the multiple transmission paths 406-1 to 406-N may be connected to one antenna array. In another example, the multiple transmission paths 406-1 to 406-N may be adaptively connected to one antenna array, or may be connected to two or more antenna arrays.

Hereinafter, the frame structure of the 5G system will be described in more detail with reference to the drawings.

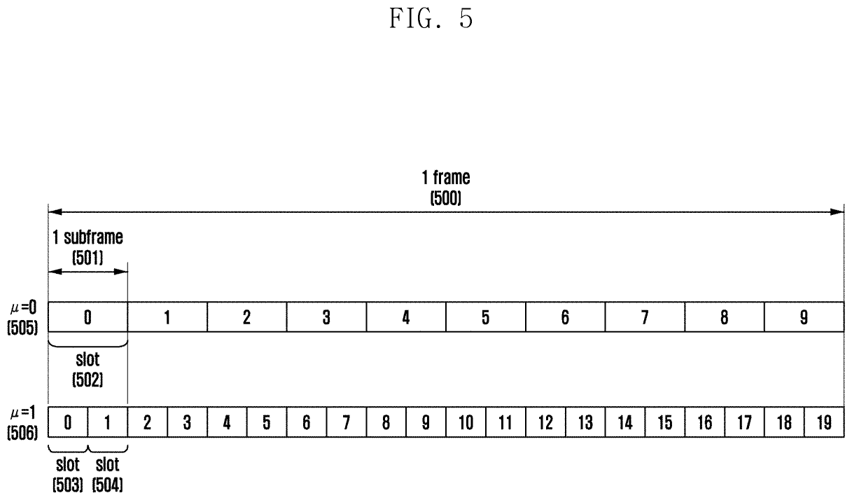

FIG. 5 illustrates a frame, subframe, and slot structure of a 5G communication system.

FIG. 5 illustrates an example of the structure of a frame 500, a subframe 501, and slots 502, 503, and 504 in a case of μ=0 (indicated by reference numeral 505) indicating a subcarrier spacing of 15 kHz and a case of μ=1 (indicated by reference numeral 506) indicating a subcarrier spacing of 30 kHz. In a case of a 5G system as shown in FIG. 5, one frame 500 may be defined as 10 ms. One subframe 501 may be defined as 1 ms, and thus, one frame 500 may be configured by a total of 10 subframes 501. One subframe 501 may include one or multiple slots. One slot may be configured by or defined by 14 OFDM symbols. That is, the number of symbols per slot (N_{symb}^{slot}) is 14. Here, the number of slots (N_{symb}^{subframe,μ}) per subframe 501 may differ according to a value (numerology) μ (indicated by reference numerals 505 or 506) indicating a configuration for subcarrier spacing. For example, if μ=0, one subframe 501 may include one slot 502, and if μ=1, one subframe 501 may include two slots 503 and 504.

Since the number of slots per subframe may differ according to the configuration value μ for the subcarrier spacing, the number of slots per frame (N_{symb}^{frame,μ}) may also differ accordingly. Each subcarrier spacing configuration value μ and N_{symb}^{subframe,μ} and N_{symb}^{frame,μ} according to μ may be defined as shown in Table 1 below. If μ=2, the terminal may additionally receive a configuration regarding a cyclic prefix from the base station via higher layer signaling. Table 1 shows a frame structure according to each subcarrier spacing.

TABLE 1
Frame structure

| | | Cyclic | | | |
|---|---|---|---|---|---|
| μ | Δƒ = 2^{μ} · 15[kHz] | prefix | N^{slot}_{symb} | N^{frameμ}ₛₗₒₜ | N^{subframeμ}ₛₗₒₜ |
| 0 | 15 | Normal | 14 | 10 | 1 |
| 1 | 30 | Normal | 14 | 20 | 2 |
| 2 | 60 | Normal, | 14 | 40 | 4 |
| | | Extended | | | |
| 3 | 120 | Normal | 14 | 80 | 8 |
| 4 | 240 | Normal | 14 | 160 | 16 |

In the present disclosure, higher layer signaling or higher layer signal may denote at least one of UE-specific or cell-specific radio resource control (RRC) signaling, packet data convergence protocol (PDCP) signaling, or media access control (MAC) control element (CE). In addition, the higher layer signaling or the higher layer signal may include system information commonly transmitted to multiple terminals, for example, a system information block (SIB), and may also include information except for master (MIB) information block) (e.g., PBCH payload) among information transmitted through a physical broadcast channel (PBCH). Here, the MIB may also be expressed as being included in the above-described higher layer signaling or higher layer signal.

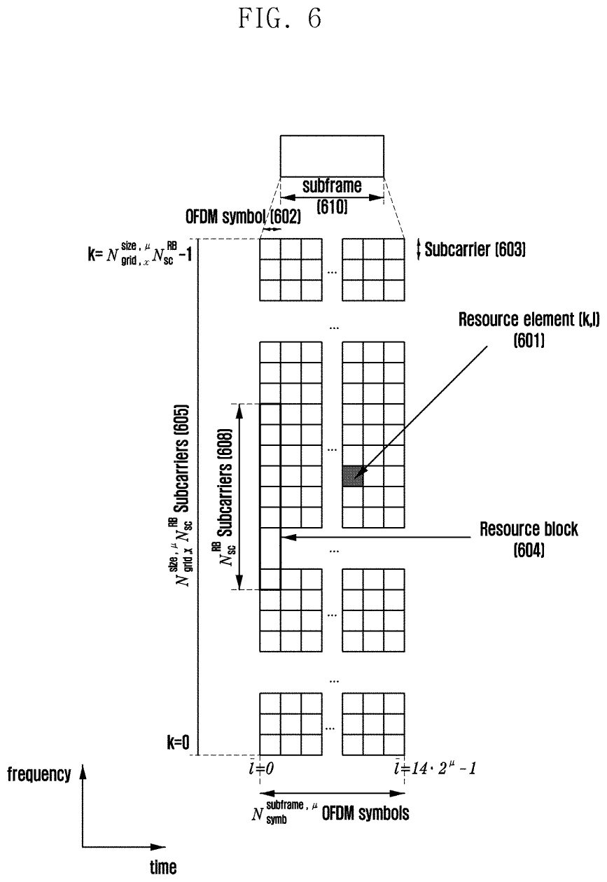

FIG. 6 illustrates a basic structure of a time-frequency domain of a 5G communication system. That is, FIG. 6 illustrates a basic structure of a time-frequency domain, which is a radio resource region in which data or a control channel is transmitted in a 5G system.

Referring to FIG. 6, the horizontal axis represents a time domain, and the vertical axis represents a frequency domain. A basic unit of resources in the time-frequency domain may be a resource element (RE) 601. The resource element 601 may be defined by 1 orthogonal frequency division multiplexing (OFDM) symbol 602 in a time domain and 1 subcarrier 603 in a frequency domain. In the frequency domain, N_{sc}^{RB} (for example, 12) consecutive REs may configure one resource block (RB) 604.

For each subcarrier spacing configuration value μ and carrier, one resource grid configured via N_{grid,x}^{size,μ}N_{sc}^{RB} subcarriers and N_{symb}^{subframe,μ} OFDM symbols may be defined starting from a common resource block (CRB) N_{grid,x}^{start,μ} indicated via higher layer signaling, and there may be one resource grid with regard to a given antenna port, subcarrier spacing configuration μ, and transmission direction (e.g., downlink, uplink, sidelink).

The base station may transfer, to the terminal, the carrier bandwidth N_{grid,x}^{size,μ} and the start position N_{grid,x}^{start,μ} of subcarrier spacing configuration μ for uplink and downlink to the terminal via higher layer signaling (e.g., higher layer parameters “carrierBandwidth” and “offsetToCarrier”). Here, the carrier bandwidth N_{grid,x}^{size,μ} is configured by the higher layer parameter “carrierBandwidth” with regard to the subcarrier spacing configuration μ, and the starting position N_{grid,x}^{start,μ} is the frequency offset of the subcarrier having the lowest frequency among the available resources of the carrier, with regard to Point A, and may be configured to be “offsetToCarrier” and expressed as the number of RBs. Here, it is also possible that N_{grid,x}^{size,μ} and N_{grid,x}^{start,μ} are values in units of subcarriers. Upon receiving the parameters, the terminal may know the start position and size of the carrier bandwidth through N_{grid,x}^{size,μ} and N_{grid,x}^{start,μ} example of higher layer signaling information for transmission of N_{grid,x}^{size,μ} and N_{grid,x}^{start,μ} is shown in Table 2 (higher layer signaling information element SCS-SpecificCarrier) below.

TABLE 2
Higher layer signaling information

```
SCS-SpecificCarrier ::= SEQUENCE {
offsetToCarrier INTEGER (0.2199),
subcarrierSpacing ,
carrierBandwidth INTEGER (1.maxNrofPhysicalResourceBlocks),
    ..,
  [[
txDirectCurrentLocation INTEGER (0.4095) OPTIONAL --
Need S
]]
}
```

Here, Point A is a value that provides a common reference point for a resource block grid. In a case of PCell downlink, the terminal may acquire Point A through “offsetToPointA” that is higher layer parameter, and in all other cases, the terminal may acquire point A through the absolute radio frequency channel number (ARFCN) configured by the higher layer parameter “absoluteFrequencyPointA”. Here, “offsetToPointA” represents a frequency offset between Point A and the lowest subcarrier of an RB having the lowest frequency among RBs overlapping with the synchronization signal/physical broadcast channel (SS/PBCH) selected or used by the terminal in the initial cell selection process of the terminal, and is expressed in RB units.

The number or index of the common resource block (CRB) is increased by 1 in the direction of increasing value from 0 in the frequency domain. Here, the center of the subcarrier index 0 of the common resource block, with regard to the subcarrier spacing μ, coincides with Point A. The frequency domain common resource block index (n_{CRB}^{μ}) and the RE of the subcarrier spacing μ have a relationship of n_{CRB}^{μ}=└k/N_{sc}^{RB}┘. Here, k is a relatively defined value with reference to Point A. That is, k=0 is Point A.

The physical resource block (PRB) of the subcarrier spacing μ is defined as a number or index from 0 to the number or index of N_{BWP,i}^{size,μ}−1 within the bandwidth part (BWP). The relationship between PRB (n_{PRB}^{μ}) and CRB (n_{CRB}^{μ}) in the bandwidth part i is indicated by n_{CRB}^{μ}=n_{PRB}^{μ}+N_{BWP,i}^{start,μ}. Here, N_{BWP,i}^{start,μ} is the number of CRBs from CRB 0 to the first RB in which the bandwidth part i starts.

Next, the bandwidth part configuration in the 5G communication system will be described in detail with reference to the drawings.

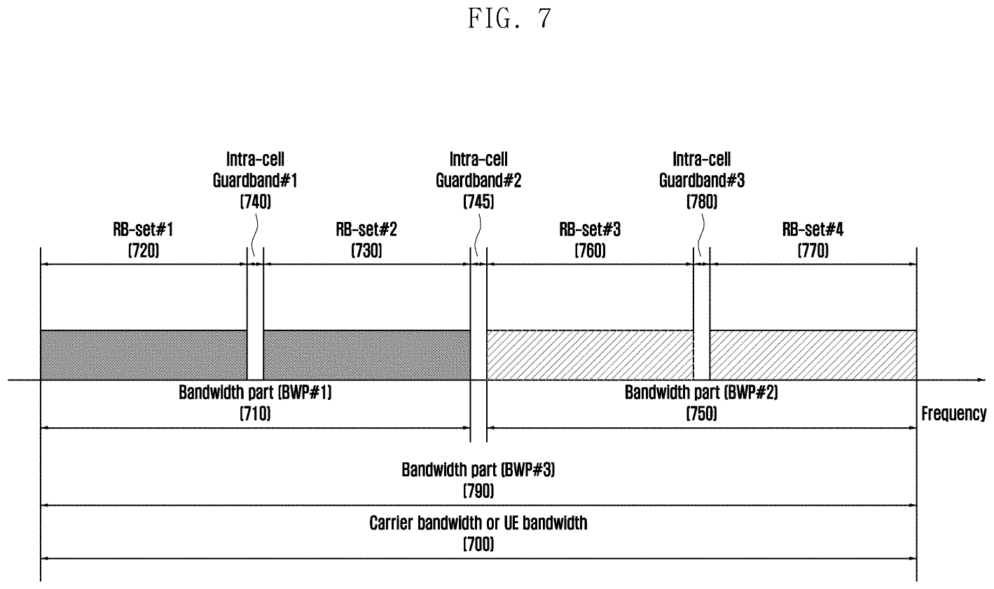

FIG. 7 illustrates an example of configuration a bandwidth part and an intra-cell guard band in a 5G communication system.

Referring to FIG. 7, multiple bandwidth parts within a carrier bandwidth or UE bandwidth 700, that is, bandwidth part #1 (BWP #1) 710, bandwidth part #2 (BWP #2) (750), and bandwidth part #3 (BWP #3) 790 may be configured. The bandwidth part #3 790 occupies the entire UE bandwidth 700. The bandwidth part #1 710 and the bandwidth part #2 750 may occupy the lower half and the higher half of the UE bandwidth 700, respectively.

The base station may provide configuration of one or multiple bandwidth parts in the uplink or downlink to the terminal, and one or more of the following higher layer parameters may be configured for each bandwidth part. Here, the bandwidth part configuration may be performed independently for the uplink and downlink. Table 3 below is an example of a higher layer signaling information element BWP for each bandwidth part.

TABLE 3
Higher layer signaling information element BWP

| | |
|---|---|
| BWP ::= | SEQUENCE { |
| bwp-Id | BWP-Id, |
| locationAndBandwidth | INTEGER (1.65536), |
| subcarrierSpacing | |
| ENUMERATED {n0, n1, n2, n3, n4, n5}, | |
| cyclicPrefix | ENUMERATED |
| { extended } | |
| } | |

Here, “bwp-Id” denotes a bandwidth part identifier, “locationAndBandwidth” indicates a frequency domain location and bandwidth of the bandwidth part, “subcarrierSpacing” indicates a subcarrier spacing used in the bandwidth part, and “cyclicPrefix” indicates whether an extended cyclic prefix (CP) is used or a normal CP is used within the bandwidth part.

In addition to the above parameters, various parameters related to the bandwidth part may be configured in the terminal. The parameters may be transmitted by the base station to the terminal via higher layer signaling, for example, RRC signaling. Within a given time, at least one bandwidth part among the configured one or multiple bandwidth parts may be activated. The activation indication for the configured bandwidth part is semi-statically transmitted from the base station to the terminal through RRC signaling or is dynamically transmitted through downlink control information (DCI) used for scheduling of a physical downlink shared channel (PDSCH) or a physical uplink shared channel (PUSCH).

According to an embodiment, the terminal before RRC connection may receive an initial bandwidth part (BWP) for initial access from the base station through a master information block (MIB). More specifically, the terminal may receive, through the MIB, configuration information about a search space and a control resource set (CORESET) through which a physical downlink control channel (PDCCH) may be transmitted in the initial access stage. Here, an identity (ID) of the control resource set and the search space configured through the MIB may be considered as 0. The base station may notify of at least one pieces of information such as frequency allocation information, time allocation information, and a numerology for a control resource set #0 through the MIB to the terminal. Here, the numerology may include at least one of a subcarrier spacing and a CP. Here, CP may denote at least one of the length of the CP or information corresponding to the length of the CP (e.g., normal or extended).

Further, the base station may notify of configuration information about an occasion and a monitoring period for the control resource set #0, that is, configuration information about a search space #0, through the MIB to the terminal. The terminal may consider a frequency domain configured as the control resource set #0 obtained from the MIB as the initial bandwidth part for initial access. In this case, an ID of the initial BWP may be considered as 0.

A configuration of a BWP supported by a 5G system described above may be used for various purposes.

According to an embodiment, if a bandwidth supported by a terminal is smaller than a system bandwidth, data transmission/reception of the terminal with regard to the system bandwidth may be supported through a configuration of a bandwidth part. For example, the base station may configure a frequency domain position of a bandwidth part in the terminal so that the terminal transmits/receives data at a specific frequency position within the system bandwidth.

According to an embodiment, in order to support different numerologies, the base station may configure a plurality of BWPs in the terminal. For example, in order to support data transmission/reception using both a subcarrier spacing of 15 kHz and a subcarrier spacing of 30 kHz to/from a predetermined terminal, the base station may configure two bandwidth parts as subcarrier spacings of 15 kHz and 30 kHz, respectively. Different bandwidth parts may be frequency division multiplexed. When data is to be transmitted or received at a specific subcarrier spacing, a bandwidth part configured as the specific subcarrier spacing may be activated.

According to an embodiment, in order to reduce power consumption of the terminal, the base station may configure bandwidth parts having different bandwidths in the terminal. For example, if the terminal supports a very large bandwidth, e.g., a bandwidth of 100 MHz, and always transmits/receives data in the bandwidth, excessively high power consumption may occur. In particular, monitoring an unnecessary downlink control channel through a large bandwidth of 100 MHz when there is no traffic may be very inefficient from the aspect of power consumption. In order to reduce power consumption of the terminal, the base station may configure a bandwidth part having a relatively small bandwidth, for example 20 MHz, in the terminal. The terminal may perform a monitoring operation in a bandwidth part of 20 MHz when there is no traffic, and when data is generated, the terminal may transmit/receive data in a bandwidth part of 100 MHz according to indication of the base station.

As described above, terminals before RRC connection may receive configuration information about an initial bandwidth part through an MIB in an initial access stage. Specifically, a terminal may receive a configuration of a control resource set (e.g., a CORESET) for a PDCCH from an MIB of a PBCH. A bandwidth of the control resource set configured through the MIB may be considered as an initial bandwidth part, and the terminal may receive a physical downlink data channel (PDSCH) through which the SIB is transmitted by using the configured initial bandwidth part. Specifically, the terminal may detect the PDCCH on the search space and the control resource set in the initial bandwidth part configured through the MIB, may receive system information block (SIB1) or remaining system information (RMSI) required for initial access through the PDSCH scheduled by the PDCCH, and may receive configuration information regarding an uplink initial bandwidth part through the SIB1 (or RMSI). The initial bandwidth part may be utilized for other system information (OSI), paging, and random access in addition to the purpose of reception of the SIB.

If one or more bandwidth parts are configured for the terminal, the base station may instruct the terminal to change the bandwidth part by using a bandwidth part indicator field in DCI.

For example, in FIG. 7, if the currently activated bandwidth part of the terminal is the bandwidth part #1 710, the base station may instruct the terminal to use the bandwidth part #2 750 using the bandwidth part indicator in the DCI, and the terminal may change a bandwidth part to the bandwidth part #2 750 indicated based on the bandwidth part indicator in the received DCI.

As described above, since the DCI-based bandwidth part change may be indicated through the DCI for scheduling the PDSCH or the PUSCH, when receiving a bandwidth part change request, the terminal may need to easily receive or transmit the PDSCH or the PUSCH scheduled by the DCI in the changed bandwidth part. To this end, the standard specification specifies a requirement for the delay time (T_{BWP}) required when changing the bandwidth part, and the standard specification may be defined, for example, as shown in Table 4 below.

TABLE 4
Delay requirement

| | | BWP switch | |
|---|---|---|---|
| | NR Slot | delay T_{BWP} (slots) | |
| μ | length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 17 |

^{Note 1}Depends on UE capability.
^{Note 2}If the BWP switch involves changing of SCS, the BWP switch delay is determined by the larger one between the SCS before BWP switch and the SCS after BWP switch.

The requirement for the bandwidth part change delay time supports type 1 or type 2 according to the capability of a terminal. The terminal may report the supportable bandwidth part delay time type to the base station.

According to the above-described requirement for the bandwidth part change delay time, if the terminal receives the DCI including the bandwidth part change indicator in slot n, the terminal may complete changes to a new bandwidth part indicated by the bandwidth part change indicator at a time point not later than slot n+ T_{BWP}, and may perform transmission/reception for the data channel scheduled by the DCI in the new changed bandwidth part. If the base station is to perform scheduling of the data channel in a new bandwidth part, the base station may determine the time domain resource allocation for the data channel by considering the bandwidth part change delay time (T_{BWP}) of the terminal. That is, when scheduling a data channel in a new bandwidth part, the base station may schedule the data channel after a bandwidth part change delay time in a method of determining time domain resource allocation for the data channel. Accordingly, the terminal may not expect the DCI indicating the bandwidth part change indicates a slot offset (K0 or K2) smaller than the bandwidth part change delay time (T_{BWP}).

If the terminal receives DCI (e.g., DCI format 1_1 or 0_1) indicating a bandwidth part change, the terminal may not perform transmission or reception during a time interval from the third symbol of a slot, though which the PDCCH including the DCI is received, to the start symbol of a slot indicated by the slot offset (K0 or K2) indicated by the time domain resource allocation field in the DCI. For example, if the terminal has received DCI indicating a bandwidth part change in slot n and the slot offset indicated through the DCI is called K, the terminal may not perform transmission or reception from the third symbol of slot n to a symbol before slot n+K (i.e., the last symbol of slot n+K−1).

The terminal may receive an intra-cell guard band with regard to one or more cells (or carriers). Here, the configuration of intra-cell guard band may be performed for each of a downlink guard band and an uplink guard band. FIG. 7 illustrates an example in which a carrier bandwidth or UE bandwidth 700 is configured by multiple intra-cell guard bands, that is, intra-cell guard band #1 740, intra-cell guard band #2 745, and intra-cell guard band #3 780. More specifically, the terminal may receive, for example, N_{RB-set,x}−1 UL/DL intra-cell guard bands in a cell or carrier through “IntraCellGuardBand-r16”, which is higher layer signaling that may be configured as follows. Here, x=DL or UL. Table 5 is an example of a higher layer signaling information element IntraCellGuardBand-r16 for configuration of an intra-cell guard band.

TABLE 5
Higher layer signaling information element

| IntraCellGuardBand-r16 ::= SEQUENCE (SIZE (1.ffsValue)) OF | |
|---|---|
| GuardBand-r16 | |
| GuardBand-r16 | ::= SEQUENCE { |
| startCRB-r16 | INTEGER (0.ffsValue), |
| nrofCRB s-r16 | INTEGER (1.ffsValue) |
| } | |

Here, “startCRB” is a start CRB index of the intra-cell guard band, and “nrofCRBs” is the length of the intra-cell guard band, which may be expressed as the number of CRBs (N) or the number of PRBs (N). Here, “nrofCRBs” may be a value indicating the last CRB index (GB_{s,x}^{end,μ}) of the intra-cell guard band. In other words, the “GuardBand” may include one or more values of (startCRB, nrofCRBs), and the first value among every two values may denote the lowest CRB index GB_{s,x}^{start,μ} of the intra-cell guard band, and the second value may denote the highest CRB index GB_{s,x}^{end,μ} of the intra-cell guard band. Here, determination as to GB_{s,x}^{end,μ}=GB_{s,x}^{start,μ}+N can be made. Here, it is also possible for the CRB index to be expressed as a PRB index. The terminal may determine the number of intra-cell guard bands (N_{RB-set,x}−1), configured by the base station, by using the number of (startCRB, nrofCRBs) pairs included in “GuardBand” or the sequence length of “GuardBand” (e.g., sequence length/2). Here, the terminal can receive, through “IntraCellGuardBand-r16,” a configuration such that an UL/DL intra-cell guard band does not exist in a cell or a carrier, or that the guard band is configured to 0. For example, if at least “startCRB-r16” has a negative value such as “−1” or has a number other than an integer, the terminal may determine that the UL/DL intra-cell guard band does not exist in a cell or a carrier through the configuration.

As described above, the terminal configured with intra-cell guard bands may divide a resource region, excluding the intra-cell guard band in the carrier or the configured bandwidth part, into a resource region or resource set (e.g., RB-set) including N_{RB-set} RBs, and may perform UL/DL transmission/reception using resources included in the resource set. Here, the resource area of each resource set may be determined as follows:
Start CRB index of the first resource set (resource set index 0): RB_{0,x}^{start,μ}=N_{grid,x}^{start,μ};
Last CRB index of the last resource set (resource set index N_{RB-set}): RB_{0,x}^{start,μ}=N_{grid,x}^{start,μ}+N_{grid,x}^{size,μ};
Start CRB index of a resource set other than the above: RB_{0,x}^{start,μ}=GB_{s,x}^{end,μ} and
End CRB index of a resource set other than the above: RB_{s,x}^{end,μ}=GB_{s,x}^{start,μ}−1.

Here, s=0, 1, . . . , N_{RB-set}−1, N_{grid,x}^{start,μ} and N_{grid,x}^{size,μ} are the first available RBs and bandwidths of the carrier according to the subcarrier spacing configuration μ, and may be configured via higher layer signaling.

FIG. 7 illustrates an example in which a carrier bandwidth or UE bandwidth 700 is configured using three intra-cell guard bands and four resource sets (N_{RB-set}−4), that is, resource set #1 720, resource set #2 730, resource set #3 760, and resource set #4 770.

The terminal may perform UL/DL transmission/reception by using an intra-cell guard band and a resource included in the resource set. For example, if the UL/DL transmission/reception resource configured or scheduled by the base station is allocated within two consecutive resource sets, the terminal may perform UL/DL transmission/reception by using an intra-cell guard band included between the resource sets.

If the terminal is not configured with the intra-cell guard band through “intraCellGuardBandx” (here, x=DL or UL) that is higher layer signaling, the terminal may determine the intra-cell guard band and resource set resource region by using a pre-defined intra-cell guard band together with the base station. Here, the intra-cell guard band may be predefined according to a subcarrier spacing and the size of a carrier or bandwidth part. In addition, the intra-cell guard band may be independently predefined for downlink and uplink, and the downlink and uplink intra-cell guard bands may be the same. Here, the predefinition of intra-cell guard band may be understood as that the start CRB index GB_{s,x}^{start,μ} of the intra-cell guard band, the last CRB index GB_{s,x}^{end,μ} of the intra-cell guard band, the lowest CRB index GB_{s,x}^{start,μ} of the intra-cell guard band, or that the highest CRB index GB_{s,x}^{end,μ} of the intra-cell guard band are predefined with regard to each intra-cell guard band in a cell.

According to an embodiment, an example in which the terminal is configured with at least one guard band among UL/DL guard bands in a specific cell or carrier is as follows. In a case of a cell performing communication through the unlicensed band, the base station may configure one or more guard bands within the bandwidth or bandwidth part according to the channel size of the unlicensed band, and the like. For example, the unlicensed band of the 5 GHz band is configured by multiple channels having a size of 20 MHz, and a guard band may exist between each channel. Accordingly, if the base station and the terminal intend to perform communication through a bandwidth or bandwidth part greater than 20 MHz, one or more guard bands may be configured within the bandwidth or bandwidth part.

For example, in a base station and a terminal performing communication through an unlicensed band having a channel size of 20 MHz, if the size of at least one bandwidth part among the bandwidth parts 710, 750, and 790, the configuration of which is received by the terminal from the base station, is greater than 20 MHz, the terminal may receive configuration such that one or more intra-cell guard bands are configured, and each bandwidth part may be configured by multiple resource sets having a size of 20 MHz according to the configuration of the intra-cell guard band. For example, the terminal may receive the configuration of two resource sets #1 720, resource set #2 730, and one intra-cell guard band #1 740 with regard to bandwidth part #1 710 of FIG. 7. The base station and the terminal may perform a channel access procedure (or listen-before-talk (LBT)) for each resource set, and may perform UL/DL transmission/reception using a resource set that has successful in channel access. Here, if the channel access procedure is successful in both of two consecutive resource sets (e.g., resource set #1 720 and resource set #2 730), resources within intra-cell guard band #740 included between the resource sets may also be used for UL/DL transmission/reception. If the channel access procedure fails in at least one resource set among two consecutive resource sets (e.g., resource set #1 720 and resource set #2 730), resources within the intra-cell guard band #1 740 included between the resource sets cannot be used for UL/DL transmission/reception.

Next, the SS/PBCH block in 5G will be described as follows.

The SS/PBCH block may denote a physical layer channel block including a primary SS (PSS), a secondary SS (SSS), and a PBCH. The details of the above are as follows:
PSS: PSS is a signal that serves as a reference for downlink time/frequency synchronization and provides some information of cell ID;
SSS: SSS serves as a reference for downlink time/frequency synchronization, and provides remaining cell ID information not provided by PSS. Additionally, it may serve as a reference signal (RS) for demodulation of the PBCH;
PBCH: PBCH provides essential system information required for transmission and reception of data channel and control channel of the terminal. The essential system information may include search space-related control information indicating radio resource mapping information of a control channel, scheduling control information of a separate data channel for transmission of system information, and the like; and
SS/PBCH block: The SS/PBCH block is configured by a combination of PSS, SSS, and PBCH. One or multiple SS/PBCH blocks may be transmitted within 5 ms, and each transmitted SS/PBCH block may be distinguished by an index.

The terminal may detect the PSS and SSS in the initial access stage, and may decode the PBCH. The terminal may acquire the MIB from the PBCH, and may receive a configuration of control resource set #0 (which may correspond to a control resource set having a control resource set index of 0) therefrom. The terminal may assume that a selected SS/PBCH block (or a SS/PBCH block that has successfully decoded the PBCH) and a demodulation reference signal (DMRS) transmitted in the control resource set #0 are in a quasi-co-located (QCL) relationship, and may perform monitoring of the control resource set #0. The terminal may acquire system information through downlink control information transmitted in the control resource set #0. The terminal may acquire random access channel (RACH)-related configuration information required for initial access from the acquired system information. The terminal may transmit a physical RACH (PRACH) to the base station by considering the selected SS/PBCH block index, and the base station having received the PRACH may obtain the SS/PBCH block index selected by the terminal. The base station may know such that the terminal has selected a predetermined block from among the SS/PBCH blocks and monitors the control resource set #0 associated with the selected block.

Next, downlink control information (DCI) in a 5G system will be described in detail as follows.

In the 5G system, scheduling information regarding uplink data (or PUSCH) or downlink data (or PDSCH) is transmitted from the base station to the terminal through DCI. The terminal may monitor or attempt to detect at least one of a DCI format for fallback and a DCI format for non-fallback for PUSCH or PDSCH. The DCI format for fallback may include fields predefined between the base station and the terminal, and the DCI format for non-fallback may include fields that may be configurable.

DCI may be transmitted through a PDCCH, which is a physical downlink control channel, through a channel coding and modulation process. A cyclic redundancy check (CRC) is attached to the payload of the DCI, and the CRC may be scrambled by a radio network temporary identifier (RNTI) corresponding to the identity of the terminal. Different RNTIs may be used according to the purpose of DCI, for example, UE-specific data transmission, power control command, or random access response. That is, the RNTI is not explicitly transmitted, but is transmitted while being included in the CRC calculation process. Upon receiving the DCI transmitted through the PDCCH, the terminal may perform CRC check using the assigned RNTI. If the result of CRC check is correct, the terminal may know that the DCI has been transmitted to the terminal.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying Transmit Power Control (TPC) may be scrambled by TPC-RNTI. DCI for scheduling UE-specific PDSCH or PUSCH may be scrambled by cell RNTI (C-RNTI).

DCI format 0_0 may be used as fallback DCI for scheduling PUSCH, and here, CRC may be scrambled by at least one of C-RNTI, CS-RNTI, and MCS-C-RNTI. DCI format 0_0 having a CRC scrambled by at least one of C-RNTI, configured scheduling (CS)-RNTI, and modulation coding scheme (MCS)-C-RNTI may include, for example, at least one of the following pieces of information:
Control information format identifier (Identifier for DCI formats): Identifier for distinguishing DCI formats. For example, a terminal, having received DCI through a 1-bit identifier, may distinguish the DCI as a UL DCI format (e.g., DCI format 0_1) if the identifier value is 0, and may distinguish the DCI as a DL DCI format (e.g., DCI format 1_0) if the identifier value is 1; or
Frequency domain resource assignment: includes ┌log₂(N_{RB}^{UL,BWP}(N_{RB}^{UL,BWP}+1)/2)┐ bit indicating RBs that are frequency domain resources allocated according to the resource allocation type 1 scheme. Here, if the terminal monitors DCI format 0_0 in a common search space, N_{RB}^{UL,BWP} is the size of the initial uplink bandwidth part, and if the terminal monitors DCI format 0_0 in a UE-specific search space, N_{RB}^{UL,BWP} is the size of the currently activated uplink bandwidth part. In other words, the bandwidth part in which the size of the frequency domain resource allocation field is determined may be different according to a search space in which the fallback DCI format is transmitted.

In an embodiment, in a case of performing PUSCH hopping, N_{UL_hop} most significant bits (MSBs) among ┌log₂(N_{RB}^{UL,BWP}(N_{RB}^{UL,BWP}+1)/2)┐ bits may be used to indicate a frequency offset. Here, it may be understood that if N_{UL_hop}=1, two offsets are configured via higher layer signaling and if N_{UL_hop}=2, four offsets are configured via higher layer signaling. In addition, a frequency domain domain resource region to which ┌log₂(N_{RB}^{UL,BWP}(N_{RB}^{UL,BWP}+1)/2)┐−N_{UL_hop} bits are allocated according to the following resource allocation type 1 is indicated.

According to an embodiment, in a case of not performing PUSCH hopping, a frequency domain resource region to which ┌log₂(N_{RB}^{UL,BWP}(N_{RB}^{UL,BWP}+1)/2)┐ bits are allocated according to resource allocation type 1 is provided.
Time domain resource assignment: 4 bits, and indicates a row index of a time domain resource allocation table including a PUSCH mapping type, a PUSCH transmission slot offset, a PUSCH start symbol, and the number of PUSCH transmission symbols. The time domain resource allocation table may be configured via higher layer signaling or may be pre-configured between the base station and the terminal including at least one of information as shown below:
Frequency hopping flag: 1 bit, and indicates that PUSCH hopping is performed (enabled) or PUSCH hopping is not performed (disabled);
Modulation and coding scheme (MCS): MCI indicates a modulation and coding scheme used for data transmission;
New data indicator (new data indicator, NDI): NDI indicates HARQ initial transmission or HARQ retransmission;
Redundancy version (RV): RV indicates a redundancy version of HARQ;
HARQ process number: HARQ process number indicates the process number of HARQ;
TPC command: TPC command indicates a transmission power control command for the scheduled PUSCH;
Padding bit: Padding bit is a field for matching the size (total number of bits) with other DCI formats (e.g., DCI format 1_0), and is inserted as 0 if necessary;
UL/SUL indicator: 1 bit, and if a cell has two or more ULs and the size of DCI format 1_0 before adding the padding bit is larger than the size of DCI format 0_0 before adding the padding bit, the UL/SUL indicator has 1 bit, otherwise the UL/SUL indicator does not exist or is 0 bit. If the UL/SUL indicator exists, the UL/SUL indicator is located in the last bit of DCI format 0_0 after the padding bit; or
ChannelAccess-CPext: 2 bits, and indicates a channel access type and a CP extension in a cell operating in an unlicensed band. In a case of a cell operating in a licensed band, ChannelAccess-CPext does not exist or is 0 bit.

With regard to DCI formats other than DCI format 0_0, the 3GPP standard specification is referred to.

Hereinafter, time domain resource allocation for a data channel in a 5G communication system will be described.

The base station may configure, in a terminal, a table regarding time domain resource allocation for a downlink data channel (PDSCH) and an uplink data channel (PUSCH) via higher layer signaling (e.g., RRC signaling), or a table regarding time domain resource allocation defined in advance between the base station and the terminal, as shown in Table 6, may be used.

For example, in a case of fallback DCI, the terminal may use a table defined in advance as shown in Table 6, and in a case of non-fallback DCI, the terminal may use a table configured via higher layer signaling.

TABLE 6
PUSCH mapping type

| Row | PUSCH | | | |
|---|---|---|---|---|
| index | mapping type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

Here, for time domain resource allocation configured via higher layer signaling, a table including up to 16 entries (maxNrofDL-Allocations=16) may be configured for the PDSCH, and a table including up to 16 entries (maxNrofUL-Allocations=16) may be configured for the PUSCH. Each table may include, for example, PDCCH-to-PDSCH slot timing (corresponding to a time interval in slot units between a time point at which a PDCCH is received and a time point at which a PDSCH scheduled by the received PDCCH is transmitted, and denoted by K₀), PDCCH-to-PUSCH slot timing (corresponding to a time interval in slot units between a time point at which a PDCCH is received and a time point at which a PUSCH scheduled by the received PDCCH is transmitted, and denoted by K₂), the position (S) and length (L) of a start symbol of the scheduled PDSCH or PUSCH within a slot, a mapping type of PDSCH or PUSCH, and the like.

If higher layer signaling is used, for example, information elements such as the PDSCH-TimeDomainResourceAllocationList information element and PUSCH-TimeDomainResourceAllocation information element of Tables 7 and 8 below may be notified from the base station to the terminal.

TABLE 7
Information element of PDSCH

PDSCH-TimeDomainResourceAllocation ::= SEQUENCE {

| | |
|---|---|
| k0 | INTEGER(0.32) OPTIONAL,-- Need S |
| mappingType | ENUMERATED {typeA, typeB }, |
| startSymbolAndLength | INTEGER (0.127) |
| } | |

TABLE 8
Information element of PUSCH

PUSCH-TimeDomainResourceAllocation ::= SEQUENCE {

| | |
|---|---|
| k2 | INTEGER(0.32) OPTIONAL,-- Need S |
| mappingType | ENUMERATED {typeA, typeB}, |
| startSymbolAndLength | INTEGER (0.127) |
| } | |

Here, “k₀” is an offset in units of slots and indicates PDCCH-to-PDSCH timing, “k₂” is an offset in units of slots and indicates PDCCH-to-PUSCH timing, and “mappingType” indicates the mapping type of PDSCH or PUSCH, and “startSymbolAndLength” indicates the start symbol and length of the PDSCH or PUSCH.

The base station may notify the terminal of one of the entries of the time domain resource allocation table via L1 signaling. For example, the entry may be indicated in a “time domain resource allocation” field in the DCI. The terminal may acquire time domain resource allocation for PDSCH or PUSCH based on a field in DCI received from the base station.

Hereinafter, frequency domain resource allocation for a data channel in a 5G communication system will be described.

As a method of indicating frequency domain resource allocation for a downlink data channel (PDSCH) and an uplink data channel (PUSCH), two types, i.e., resource allocation type 0 and resource allocation type 1, are supported.

Resource allocation type 0 is a method of allocating resources in units of a resource block group (RBG) including P consecutive RBs, and may be notified from the base station to the terminal in the form of a bitmap. Here, the RBG may include a set of consecutive virtual RBs (VRBs), and the size P of the RBG (nominal RBG size P) may be determined based on a value configured through a higher layer parameter (rbg-Size) and the size value of the bandwidth part defined in Table 9 below.

TABLE 9
Bandwidth part size and configurations

| Bandwidth | | |
|---|---|---|
| Part Size | Configuration 1 | Configuration 2 |
| 1-36 | 2 | 4 |
| 37-72 | 4 | 8 |
| 73-144 | 8 | 16 |
| 145-275 | 16 | 16 |

Here, the total number (N_{RBB}) of RBGs in bandwidth part i having the size of N_{BWP,s}^{size} is N_{RBG}=┌(N_{BWP,s}^{size}+(N_{BWP,i}^{start} mod P))/P┐. Here, the size of the first RBG is RBG₀^{size}=P−N_{BWP,i}^{start} mod P. If (N_{BWP,i}^{start}+N_{BWP,i}^{size})mod P>0, the size RBGₗₐₛₜ^{size} of the last RBG is RBGₗₐₛₜ^{size}=(N_{BWP,i}^{start}+N_{BWP,i}^{size})mod P, and otherwise, RBGₗₐₛₜ^{size} is P. The size of all other RBGs is P Each bit of the N_{RBG} bit-sized bitmap may correspond to each RBG. RBGs may be indexed in the order of increasing frequency, starting from the lowest frequency position of the bandwidth part. With regard to N_{RBG} RBGs in the bandwidth part, RBG #0 to RBG # (N_{RBG}−1) may be mapped from MSB to LSB of the RBG bitmap. If a specific bit value in the bitmap is 1, the terminal may determine that the RBG corresponding to the bit value has been allocated, and if the specific bit value in the bitmap is 0, the terminal may determine that an RBG corresponding to the bit value has not been allocated.

Resource allocation type 1 is a method for allocation of resources based on the start position and length of consecutively allocated VRBs. Here, interleaving or non-interleaving may be additionally applied to consecutively allocated VRBs. The resource allocation field of resource allocation type 1 may include a resource indication value (RIV), and the RIV may include the start point RBₛₜₐᵣₜ of the VRB and the length L_{RBs} of the consecutively allocated RB. RBₛₜₐᵣₜ may be the first PRB index at which resource allocation starts, and L_{RBs} may be the length or number of consecutively allocated PRBs. More specifically, the RIV in the bandwidth part of the size N_{BWP}^{size} may be defined as follows.

$$If ( {L}_{RBs} - 1 ) \leq ⌊ \frac{{N}_{BWP}^{size}}{2} ⌋ then RIV = {N}_{BWP}^{size} ( {L}_{RBs} - 1 ) + {RB}_{start}$$

$$Else , RIV = {N}_{BWP}^{size} ( {N}_{BWP}^{size} - {L}_{RBs} - 1 ) + ( {N}_{BWP}^{size} - 1 - {RB}_{start} )$$

$$where , {L}_{RBs} \geq 1 and shall not exeed {N}_{BWP}^{size} - {RB}_{start} .$$

Here, N_{BWP}^{size} may differ according to a search space in which the fallback DCI format (e.g., DCI format 0_0 or DCI format 1_0) is transmitted. For example, if DCI format 0_0, which is a fallback DCI format from among DCI (i.e., uplink (UL) grant) for configuring or scheduling uplink transmission, is transmitted in a common search space (CSS), the size of the initial uplink bandwidth part N_{BWP,0}^{size} or N_{BWP}^{initial} NBWP may be used as N_{BWP}^{size}. Similarly, if DCI format 1_0, which is a fallback DCI format from among DCI (i.e., uplink (UL) grant) for configuration or scheduling of downlink transmission, is transmitted in a common search space (CSS), N_{BWP}^{size} and/or N_{BWP}^{initial} is the size of a control resource set #0 if the control resource set #0 is configured in the cell and is the size of the initial downlink bandwidth part if the control resource set #0 is not configured.

Here, if DCI format 0_0 or DCI format 1_0, which is a fallback DCI format, is transmitted in a UE-specific search space (USS), or if the size of a fallback DCI format, which is transmitted in a UE-specific search space, is determined through the size of the initial uplink bandwidth part or the initial downlink bandwidth part but if the DCI is applied to another active bandwidth part of the size N_{BWP}^{active}, RIV corresponds to RBₛₜₐᵣₜ=0, K, 2K, . . . , (N_{BWP}^{initial}−1)K, N_{BWP}^{initial} and L_{RBs}=K, 2K, . . . , N_{BWP}^{initial}K, and RIV is defined as follows.
If (L′_{RBS}−1)≤└N_{BWP}^{initial}/2┘ then RIV=N_{BWP}^{initial}(L′_{RBS}−1)+RB′ₛₜₐᵣₜ
Else, RIV=N_{BWP}^{intial} (N_{BWP}^{initial}−L′_{RBS}−1)+(N_{BWP}^{intial}−1−RB′ₛₜₐᵣₜ)
where, L′_{RBS}=L_{RBS}/K, RB′ₛₜₐᵣₜ=RBₛₜₐᵣₜ/K,L′_{RBS} shall not exceed N_{BWP}−RB′ₛₜₐᵣₜ

Here, if N_{BWP}^{active}>N_{BWP}^{initial}, K is the largest value that satisfies K≤└N_{BWP}^{active}/N_{BWP}^{initial}┘ among a set {1, 2, 4, 8}. Otherwise (N_{BWP}^{active}≤N_{BWP}^{initial}), K is 1.

The base station may configure a resource allocation type via higher layer signaling in the terminal. For example, higher layer parameter resource Allocation may be configured as one of resourceAllocationType0, resourceAllocationType1, or dynamicSwitch. If the terminal is configured to receive both resource allocation types 0 and 1 or if the higher layer parameter resourceAllocation is configured as dynamicSwitch, the most significant bit (MSB) of the resource allocation field in the DCI format indicating scheduling may indicate either resource allocation type 0 or resource allocation type 1, resource allocation information may be indicated through the remaining bits except for the MSB of the resource allocation field based on the indicated resource allocation type, and the terminal may interpret the resource allocation information of DCI based on the resource allocation type. If the terminal is configured to receive resource allocation type 0 or resource allocation type 1, or if the higher layer parameter resource allocation is configured as one of resourceAllocationType0 or resourceAllocationType1, the resource allocation field in the DCI format indicating scheduling may indicate resource allocation information based on the configured resource allocation type, and the terminal may interpret resource allocation information of DCI based on the configured resource allocation type.

Hereinafter, a downlink control channel in a 5G communication system will be described in more detail with reference to the drawings.

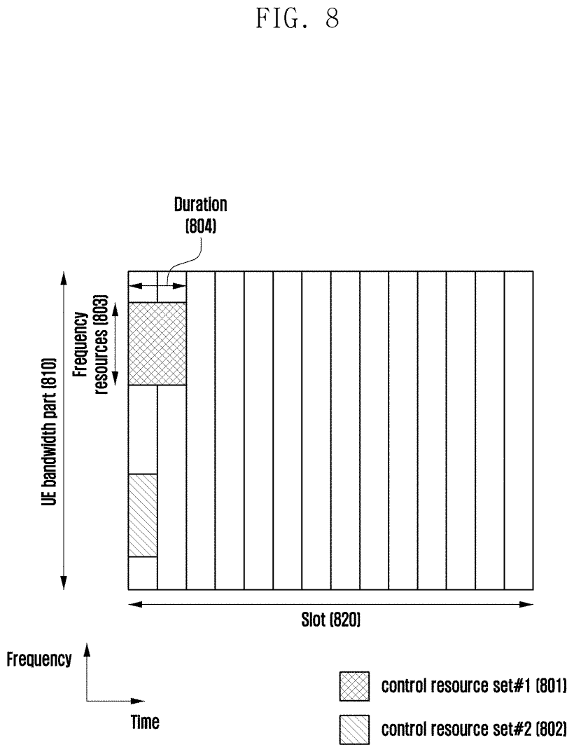

FIG. 8 illustrates an example of a configuration of a control resource set of a downlink control channel of a 5G communication system. That is, FIG. 8 illustrates a control resource set (CORESET) where a downlink control channel is transmitted in a 5G wireless communication system.

Referring to FIG. 8, two control resource set, i.e., control resource set #1 801 and control resource set #2 802 are configured in a UE bandwidth part 810 in a frequency domain and one slot 820 in a time domain. The control resource sets 801 and 802 may be configured in a specific frequency resource 803 within the UE bandwidth part 810 in a frequency domain. The control resource sets may be configured by one or multiple OFDM symbols in a time domain. The OFDM symbols may be defined by a control resource set duration 804. Referring to the illustrated example, the control resource set #1 801 may be configured as a two-symbol control resource set duration, and the control resource set #2 802 may be configured as a one-symbol control resource set duration.

Each control resource set describe above may be configured in a terminal by a base station via higher layer signaling, for example, one of system information, master information block (MIB), or radio resource control (RRC) signaling. Configuration of the control resource set in the terminal denotes that information such as a control resource set identifier, a frequency position of a control resource set, and a symbol length of a control resource set is provided. For example, a higher layer signaling information element for configuration of a control resource set or control resource set configuration information may include pieces of information of ControlResourceSet information element as shown in Table 10, as follows.

TABLE 10
CORESET information elements

ControlResourceSet ::= SEQUENCE {
controlResourceSetId ControlResourceSetId,
frequencyDomainResources BIT STRING (SIZE (45)),
duration INTEGER (1.maxCoReSetDuration),
cce-REG-MappingType CHOICE {
interleaved SEQUENCE {
reg-BundleSize ENUMERATED {n2, n3, n6},
interleaverSize ENUMERATED {n2, n3, n6},
shiftIndex INTEGER(0.maxNrofPhysicalResourceBlocks-1) OPTIONAL--
Need S
},
nonInterleaved NULL
},
precoderGranularity ENUMERATED {sameAsREG-bundle,
allContiguousRBs},
tci-StatesPDCCH-ToAddList SEQUENCE(SIZE (1.maxNrofTCI-
StatesPDCCH)) OF TCI-StateId OPTIONAL,-- Cond NotSIB1-initialBWP
tci-StatesPDCCH-ToReleaseList SEQUENCE(SIZE (1.maxNrofTCI-
StatesPDCCH)) OF TCI-StateId OPTIONAL,-- Cond NotSIB1-initialBWP
tci-PresentInDCI ENUMERATED {enabled} OPTIONAL,-- Need S
pdcch-DMRS-ScramblingID INTEGER (0.65535) OPTIONAL,-- Need S
}

Here, “controlResourceSetId” indicates a control resource set identifier (Identity), “frequencyDomainResources” indicates a frequency domain resource, and “duration” indicates a time interval of a control resource set, that is, a time domain resource, and “cce-REG”-MappingType” indicates a CCE-to-REG mapping method, “reg-BundleSize” indicates a REG bundle size, “interleaverSize” indicates an interleaver size, and “shiftIndex” indicates an interleaver shift (Shift).

In addition, the tci-StatesPDCCH is configuration information of transmission configuration indication (TCI) states, and may include one or multiple SS/PBCH block indexes or channel state information reference signal (CSI-RS) index having a quasi-co-located (QCL) relationship with a DMRS transmitted in the corresponding control resource set.

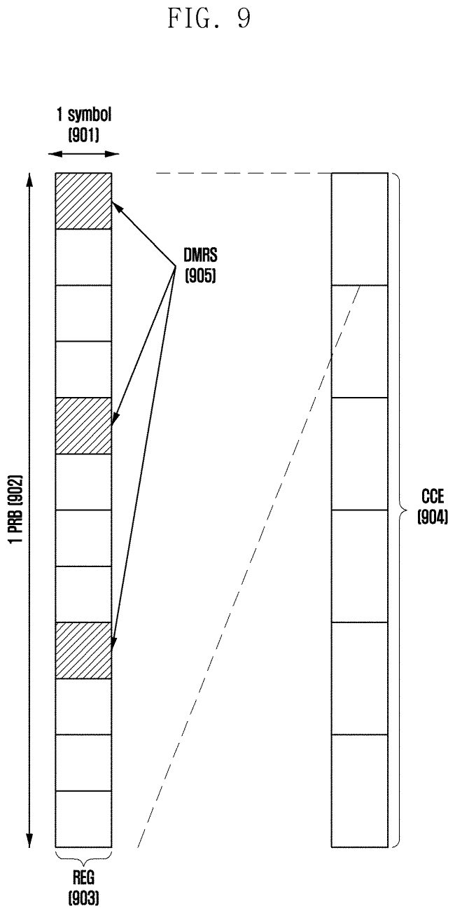

FIG. 9 illustrates a structure of a downlink control channel of a 5G communication system. That is, FIG. 9 illustrates a basic unit of a time-and-frequency resource constituting a downlink control channel that may be used in 5G wireless communication system.

Referring to FIG. 9, the basic unit of the time-and-frequency resource constituting the control channel may be referred to as a resource element group (REG) 903. The REG 903 may be defined by one OFDM symbol 901 in a time domain and one PRB 902, that is, 12 subcarriers, in a frequency domain. A base station may configure a downlink control channel allocation unit in concatenation with at least one REG 903.

When a basic unit in which a downlink control channel is allocated in 5G is a control channel element (CCE) 904, one CCE 904 may include a plurality of REGs 903. When explaining an example of the illustrated REG 903, the REG 903 may include 12 REs, and when one CCE 904 includes 6 REGs 903, one CCE 904 may include 72 REs. A region in which a downlink control resource set is configured may include a plurality of CCEs 904, and a specific downlink control channel may be mapped to one or multiple CCEs 904 according to an aggregation level (AL) in the control resource set. The CCEs 904 in the control resource set may be distinguished with numbers, and here, the numbers of the CCEs 904 may be assigned according to a logical mapping scheme.

The basic unit, that is, the REG 903, of the downlink control channel may include a region of REs to which DCI is mapped and a region to which a DRMS 905 used for decoding the DCI is mapped. At least one (three in a case of illustrated example) DRMS 905 may be transmitted in one REG 903. The number of CCEs required for transmission of a downlink control channel may be 1, 2, 8, 8, or 16 according to an aggregation level (AL), and different numbers of CCEs may be used to implement link adaptation of the downlink control channel. For example, if AL=L, one downlink control channel may be transmitted through L CCEs. A terminal may detect a signal without knowing information about the downlink control channel, and a search space denoting a set of CCEs for blind decoding may be defined. The search space is a set of downlink control channel candidates including CCEs which the terminal has to attempt to decode at a given aggregation level. Since there are several aggregation levels for bundling up 1, 2, 8, 8, or 16 CCEs, the terminal may include a plurality of search spaces. A search space set may be defined as a set of search spaces at all configured aggregation levels.

A search space for a PDCCH may be classified into a common search space (CSS) and a UE-specific search space (USS). A predetermined group of terminals or all terminals may investigate a common search space to receive cell-common control information such as a paging message or dynamic scheduling for system information. For example, the terminals may detect PDSCH scheduling allocation information for transmission of SIB including cell service provider information or the like by investigating the common search space. A common search space may be defined as a set of CCEs that are previously agreed on so that a predetermined group of terminals or all terminals can receive a PDCCH. Scheduling allocation information for a UE-specific PDSCH or PUSCH may be detected by investigating a UE-specific search space. The UE-specific search space may be UE-specifically defined through a function of various system parameters and an identity of the terminal.

In a 5G wireless communication system, parameters for a search space of a PDCCH may be configured by a base station in a terminal via higher layer signaling (e.g., SIB, MIB, and RRC signaling). For example, the base station may configure, in the terminal, the number of PDCCH candidates at each aggregation level L, a monitoring period for the search space, a monitoring occasion of a symbol unit within a slot for the search space, a search space type (e.g., a common search space or a UE-specific search space), a combination of a DCI format and an RNTI to be monitored in the search space, and a control resource set index for monitoring the search space. For example, the higher layer signaling information element for configuring parameters for the search space of the PDCCH may include SearchSpace information element information as shown in Table 11 below.

TABLE 11
Search space information element

| | |
|---|---|
| SearchSpace ::= | SEQUENCE { |
| searchSpaceId | SearchSpaceId, |
| controlResourceSetId | ControlResourceSetId |
| Cond SetupOnly | OPTIONAL,-- |
| monitoringSlotPeriodicityAndOffset | CHOICE { |
| sl1 NULL, | |
| sl2 INTEGER (0.1), | |
| .. | |
| } | |
| OPTIONAL, -- Cond Setup | |

```
  duration INTEGER (2.2559) OPTIONAL,  -- Need R
  monitoringSymbolsWithinSlot BIT STRING (SIZE (14))
```

| | |
|---|---|
| OPTIONAL,-- Cond Setup | |
| nrofCandidates | SEQUENCE { |
| aggregationLevel1 | ENUMERATED {n0, n1, n2, |
| n3, n4, n5, n6, n8}, | |
| aggregationLeve12 | ENUMERATED {n0, n1, n2, |
| n3, n4, n5, n6, n8}, | |
| aggregationLeve14 | ENUMERATED {n0, n1, n2, |
| n3, n4, n5, n6, n8}, | |
| aggregationLeve18 | ENUMERATED {n0, n1, n2, |
| n3, n4, n5, n6, n8}, | |
| aggregationLevel16 | ENUMERATED {n0, n1, n2, |
| n3, n4, n5, n6, n8} | |
| } | |
| OPTIONAL, -- Cond Setup | |
| searchSpaceType | CHOICE { |
| common | SEQUENCE { |

```
      dci-Format0-0-AndFormat1-0 SEQUENCE {
..
    },
```

| | |
|---|---|
| ue-Specific | SEQUENCE { |

```
dci-Formats ENUMERATED {formats0-0-And-1-0, formats0-1-And-1-1},
..
    }
  } OPTIONAL -- Cond Setup2
}
```

Here, “searchSpaceId” indicates a search space identifier, “controlResourceSetId” indicates a control resource set identifier, “monitoringSlotPeriodicityAndOffset” indicates a monitoring slot level period, “duration” indicates a length of a time interval to be monitored, “monitoringSymbolsWithinSlot” indicates symbols for monitoring PDCCH in the slot, “nrofCandidates” indicates the number of PDCCH candidates for each aggregation level, “searchSpaceType” indicates a search space type, and “common” includes parameters for a common search space, and “ue-Specific” includes parameters for a UE-specific search space.

According to the configuration information, the base station may configure one or multiple search space sets for the terminal. According to an embodiment, the base station may configure search space set 1 and search space set 2 in the terminal, and may configure a DCI format A scrambled by an X-RNTI in the search space set 1 to be monitored in a common search space and DCI format B scrambled by a Y-RNTI in search space set 2 to be monitored in a UE-specific search space.

According to the configuration information, one or multiple search space sets may exist in a common search space or a UE-specific search space. For example, the search space set #1 and the search space set #2 may be configured as the common search space, and the search space set #3 and the search space set #4 may be configured as the UE-specific search space.

In the common search space, a combination of the following DCI format and RNTI may be monitored. It is needless to say that it is not limited to the following examples:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
DCI format 2_2 with CRC scrambled by TPC-PUSCH-RNTI, TPC-PUCCH-RNTI; and
DCI format 2_3 with CRC scrambled by TPC-SRS-RNTI.

In the UE-specific search space, a combination of the following DCI format and RNTI may be monitored. It is needless to say that it is limited to the following examples:
DCI format 0_0/1_0 with CRC scrambled by C-RNTI, CS-RNTI, TC-RNTI; and
DCI format 1_0/1_1 with CRC scrambled by C-RNTI, CS-RNTI, TC-RNTI;

Specified RNTIs may follow the definitions and uses below:
Cell RNTI (C-RNTI): C-RNTI is used for scheduling a UE-specific PDSCH;
Temporary Cell RNTI (TC-RNTI): TC-RNTI is used for scheduling a UE-specific PDSCH;
Configured scheduling RNTI (CS-RNTI): CS-RNTI is used for scheduling a semi-statically configured UE-specific PDSCH;
Random access RNTI (RA-RNTI): RA-RNTI is used for scheduling a PDSCH in a random access stage;
Paging RNTI (P-RNTI): P-RNTI is used for scheduling a PDSCH for transmission of paging;
System information RNTI (SI-RNTI): SI-RNTI is used for scheduling a PDSCH for transmission of system information;
Interruption RNTI (INT-RNTI): INT-RNTI is used for notifying of whether a PDSCH is punctured;
Transmit power control for PUSCH RNTI (TPC-PUSCH-RNTI): TPC-PUSCH-RNTI is used for indicating a power control command for a PUSCH;
Transmit power control for PUCCH RNTI (TPC-PUCCH-RNTI): TPC-PUCCHORNTI is used for indicating a power control command for a PUCCH; and
Transmit power control for SRS RNTI (TPC-SRS-RNTI): TPC-SRS-RNTI is used for indicating a power control command for a sounding reference signal (SRS).

The above DCI formats may follow the definitions shown in Table 12 below.

TABLE 12
Definition of DCI format

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands |
| | for PUCCH and PUSCH |
| 2_3 | Transmission of a group of TPC commands |
| | for SRS transmissions by one or more UEs |

In a 5G communication system such as NR, a physical channel and a physical signal may be distinguished as follows. For example, the UL/DL physical channel refers to a set of REs for transferring information transmitted through a higher layer, and representatively includes PDCCH, PUCCH, PDSCH, PUSCH, and the like. The UL/DL physical signal refers to a signal used in the physical layer without transferring information transmitted through the higher layer, and representatively includes DM-RS, CSI-RS, and SRS.

The disclosure may describe, without distinction between a physical channel and a physical signal in the above, as a signal. For example, transmission of a downlink signal by a base station may denote that the base station transmits at least one of a downlink physical channel and a downlink physical signal, such as PDCCH, PDSCH, DM-RS, and CSI-RS. In other words, the signal in the disclosure is a term that includes both the channel and the signal, and may be classified according to context and cases in a case in which the distinction is actually required.

In the 5G communication system, the downlink signal transmission duration and the uplink signal transmission duration may be dynamically changed. To this end, the base station may indicate to the terminal whether each of OFDM symbols included in the one slot is a downlink symbol, an uplink symbol, or a flexible symbol by means of a slot format indicator (SFI). Here, the flexible symbol may denote a symbol which is neither a downlink nor uplink symbol but can be changed to a downlink or uplink symbol using UE-specific control information or scheduling information. Here, the flexible symbol may include a gap guard required for a process of switching from the downlink to the uplink.

Upon receiving the slot format indicator, the terminal may perform a downlink signal reception operation from the base station in a symbol indicated as a downlink symbol, and may perform an uplink signal transmission operation to the base station in a symbol indicated as an uplink symbol. For a symbol indicated as a flexible symbol, the terminal may perform at least a PDCCH monitoring operation, and the terminal may perform, through another indicator, for example, DCI, a downlink signal reception operation from the base station in the flexible symbol (for example, when DCI format 1_0 or 1_1 is received), or may perform an uplink signal transmission operation to the base station (for example, when DCI format 0_0 or 0_1 is received).

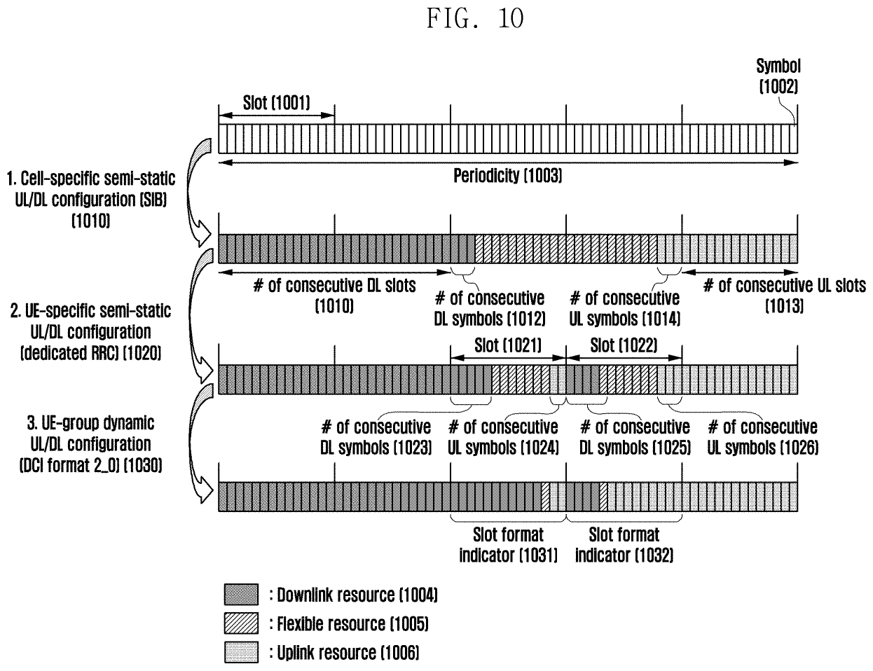

FIG. 10 illustrates an example of UL/DL configuration in a 5G system, in which three operations of UL-DL configuration of symbol/slot are illustrated.

Referring to FIG. 10, in the first operation, cell-specific configuration information 1010 for semi-static UL-DL configuration, for example, system information such as SIB configures UL-DL of symbol/slot. Specifically, the cell-specific UL-DL configuration information 1010 in the system information may include UL-DL pattern information and information indicating a reference subcarrier spacing. The UL-DL pattern information may indicate a transmission periodicity 1003 of each pattern, the number of consecutive full DL slots at the beginning of each DL-UL pattern (indicated by reference numeral 1011), the number of consecutive DL symbols in the beginning of the slot following the last full DL slot (indicated by reference numeral 1012), the number of consecutive full UL slots at the end of each DL-UL pattern (indicated by reference numeral 1013), and the number of consecutive UL symbols in the end of the slot preceding the first full UL slot (indicated by reference numeral 1014). Here, the terminal may determine a slot/symbol that is not indicated for uplink or downlink to be a flexible slot/symbol.

In the second operation, UE-specific configuration information 1020 transferred through UE-dedicated higher layer signaling (i.e., RRC signaling) indicates symbols to be configured for downlink or uplink in the flexible slot or slots 1021 and 1022 including a flexible symbol. For example, the UE-specific UL-DL configuration information 1020 may include a slot index indicating slots 1021 and 1022 including a flexible symbol, the number of consecutive DL symbols in the beginning of each slot (indicated by reference numerals 1023 and 1025), and the number of consecutive UL symbols in the end of each slot (indicated by reference numerals 1024 and 1026), or may include information indicating the entire downlink or information indicating the entire uplink with regard to each slot. Here, a symbol/slot configured for uplink or downlink through the cell-specific configuration information 1010 of the first operation cannot be changed to downlink or uplink through the UE-specific higher layer signaling 1020.

Finally, in order to dynamically change the downlink signal transmission duration and the uplink signal transmission duration, the downlink control information of the downlink control channel includes a slot format indicator 1030 indicating whether each of OFDM symbols included in each slot, among multiple slots starting from a slot in which the terminal detects the downlink control information, is a downlink symbol, an uplink symbol, or a flexible symbol. Here, with regard to the symbol/slot configured for uplink or downlink in the first and second operations, the slot format indicator cannot indicate that it is configured for downlink or uplink. The symbol/slot may be indicated through downlink control information corresponding to the slot format of each of slots 1031 and 1032 including at least one symbol that is not configured for uplink or downlink in the first and second operations.

The slot format indicator may indicate the UL-DL configuration for 14 symbols in one slot as shown in Table 13 below. The slot format indicator may be simultaneously transmitted to multiple terminals through a terminal group (or cell) common control channel. In other words, the downlink control information including the slot format indicator may be transmitted through a CRC-scrambled PDCCH by an identifier, which is different from the UE-specific cell-RNTI (C-RNTI), for example, an SFI-RNTI. The downlink control information may include a slot format indicator for one or more slots, that is, N slots. Here, the value of N may be an integer greater than 0, or a value which is configured among a set of predefined possible values, such as 1, 2, 5, 10, 20, or the like and received by the terminal through higher layer signaling from the base station. The size of the slot format indicator may be configured in the terminal by the base station via higher layer signaling. Table 13 is a table describing the contents of the SFI.

TABLE 13
Contents of SFI

| | Symbol number (or index) in one slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| . . . | | | | | | | | | | | | | | |
| 9 | F | F | F | F | F | F | F | F | F | F | F | F | U | U |
| . . . | | | | | | | | | | | | | | |
| 19 | D | F | F | F | F | F | F | F | F | F | F | F | F | U |
| . . . | | | | | | | | | | | | | | |
| 54 | F | F | F | F | F | F | F | D | D | D | D | D | D | D |
| 55 | D | D | F | F | F | U | U | U | D | D | D | D | D | D |
| 56-254 | Reserved | | | | | | | | | | | | | |

| | |
|---|---|
| 255 | UE determines the slot format for the slot based on tdd-UL-DL-ConfigurationCommon, |
| | or tdd-UL-DL-ConfigurationDedicated and, if any, on detected DCI formats |

In Table 13, D denotes a downlink symbol, U denotes an uplink symbol, and F denotes a flexible symbol. According to Table 13, the total number of supportable slot formats for one slot is 256. The maximum size of information bits that may be used for slot format indication in the NR system is 128 bits, and the base station may configure the size of information bits in the terminal via higher layer signaling, for example, “dci-PayloadSize.”

Here, a cell operating in an unlicensed band may configure and indicate the additional slot format as shown in Table 14 by introducing one or more additional slot formats or modifying at least one or more of the existing slot formats. Table 14 shows an example of additional slot formats in which only an uplink symbol and a flexible symbol F are included in one slot.

TABLE 14
Slot format

| | Symbol number(or index) in one slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 56 | F | U | U | U | U | U | U | U | U | U | U | U | U | U |
| 57 | F | F | U | U | U | U | U | U | U | U | U | U | U | U |
| 58 | U | U | U | U | U | U | U | U | U | U | U | U | U | F |
| 59 | U | U | U | U | U | U | U | U | U | U | U | U | F | F |
| . . . | | | | | | | | | | | | | | |

In an embodiment, downlink control information used for slot format indication may indicate slot format(s) for multiple serving cells, and the slot format(s) for each serving cell may be distinguished through a serving cell ID. Further, a slot format combination for one or more slots, with regard to each serving cell, may be indicated by the downlink control information. For example, if the size of one slot format indicator index field in the downlink control information is 3 bits and indicates the slot format for one serving cell, the 3-bit slot format indicator index field may indicate one of a total of 8 slot formats (or slot format combinations), and the base station may indicate the slot format indicator index field through terminal group common downlink control information (common DCI).

In an embodiment, at least one slot format indicator index field included in the downlink control information may be configured as a slot format combination indicator for multiple slots. For example, Table 15 shows a 3-bit slot format combination indicator configured by the slot formats of Tables 13 and 14. Among the values of the slot format combination indicator, {0, 1, 2, 3, 4} indicate the slot format for one slot. The remaining three values {5, 6, 7} indicate the slot format for 4 slots, and the terminal may apply the indicated slot format to 4 slots sequentially from a slot in which the downlink control information including the slot format combination indicator is detected.

TABLE 15
3-bit slot format

| Slot format | Slot |
|---|---|
| combination ID | Formats |
| 0 | 0 |
| 1 | 1 |
| 2 | 2 |
| 3 | 19 |
| 4 | 9 |
| 5 | 0 0 0 0 |
| 6 | 1 1 1 1 |
| 7 | 2 2 2 2 |

In a case of a system performing communication in an unlicensed band, a communication device (a base station or a terminal) that intends to transmit a signal through the unlicensed band may perform a channel access procedure, listen-before talk (LBT), or channel sensing for the unlicensed band in which communication is to be performed before signal transmission, and when it is determined that the unlicensed band is in an idle state according to the channel access procedure, the communication device may access the unlicensed band and perform signal transmission. If it is determined that the unlicensed band is not in an idle state according to the performed channel access procedure, the communication device may not perform signal transmission. Here, the channel access procedure denotes a procedure in which the base station or the terminal occupies a channel for a fixed (deterministic) time or a predetermined time, measures the strength of a signal received through a channel for transmission of the signal, and compares the measured signal strength with a predefined threshold or a threshold calculated by a function, the value of which is determined by at least one of a channel bandwidth, a signal bandwidth in which a signal for transmission is transmitted, and/or an intensity of transmission power.

If the strength of the received signal, measured through sensing for the unlicensed band channel, is smaller than X_{Thresh} the base station and the terminal may determine that the channel is in an idle state or that the channel use (or channel occupancy) is possible, and may occupy and use the channel. If the sensing result is equal to or greater than X_{Thresh} the base station and the terminal may not use the channel by determining that the channel is in a busy state or determining that the channel cannot be used (or cannot be occupied). Here, the base station and the terminal may continuously perform sensing until it is determined that the channel is in an idle state. In other words, the channel access procedure in the unlicensed band may denote a procedure for assessment of the possibility of performing transmission in the channel based on sensing. The basic unit of sensing is a sensing slot and may be a Tₛₗ=9 μs duration. Here, if power detected in at least 4 μs of the sensing slot duration is smaller than X_{Thresh}, the sensing slot duration may be regarded as idle or not being used. If the power detected in at least 4 μs of the sensing slot duration is equal to or greater than X_{Thresh}, the sensing slot duration may be regarded as being busy or being used by another device.

The channel access procedure in the unlicensed band may be distinguished according to whether the channel access procedure start time of the communication device is fixed (frame-based equipment (FBE)) (or semi-static), or variable (load-based equipment (LBE)) (or dynamic). In addition to the channel access procedure start time, the communication device may be determined as an FBE device or an LBE device according to whether the transmit/receive structure of the communication device has one period or does not have one period. Here, the fixed channel access procedure start time may be understood as that the channel access procedure of the communication device may be started periodically according to a predefined declaration or a configured period. As another example, the fixed channel access procedure start time may be understood as that the transmit/receive structure of the communication device has one period. Here, the variable channel access procedure start time may be understood as that the channel access procedure start time of the communication device is possible at any time if the communication device intends to transmit a signal through the unlicensed band. As another example, the variable starting time of the channel access procedure may be understood as that the transmit/receive structure of the communication device does not have one period and the period may be determined as needed. Hereinafter, although the channel access procedure and the channel sensing are used interchangeably in the disclosure, the channel access procedure or the channel sensing operation of the base station or the terminal may be the same.

Hereinafter, in the disclosure, a DL transmission burst may be defined as follows. The DL transmission burst may denote a set of DL transmissions transmitted without a gap larger than 16 μs between DL transmissions of the base station. If a gap between DL transmissions is larger than 16 μs, the DL transmission may denote separate DL transmission bursts. Similarly, an UL transmission burst may be defined as follows. The UL transmission burst may denote a set of UL transmissions transmitted without a gap larger than 16 μS between UL transmissions of the terminal. If a gap between UL transmissions is larger than 16 μs, the UL transmission may denote separate UL transmission bursts.

Hereinafter, a channel access procedure in a case where the channel access procedure start time of a communication device is fixed or semi-statically configured will be described.

In a 5G system that performs communication in an unlicensed band, if the absence of other systems that share and use unlicensed band channels for a long time is guaranteed by a regulation-based method and by level of regulation, the following semi-static channel access procedure or channel sensing may be performed.

A base station desiring to use the semi-static channel access procedure may provide, to a terminal, configuration information denoting that the channel access procedure scheme of the base station is a semi-static channel access procedure and/or configuration information about the semi-static channel access via higher layer signaling (e.g., SIM and/or RRC signaling), so that the terminal may know whether the channel access procedure method of the base station is the semi-static channel access scheme. Here, as an example of the configuration information about the semi-static channel access, there may be a period (Tₓ) during which channel occupancy by the base station can be initiated. For example, the value of the period may be 1 ms, 2 ms, 2.5 ms, 4 ms, 5 ms, or 10 ms. In a case of using the semi-static channel access procedure, a periodic channel occupancy can be initiated by the base station every Tₓ within every two consecutive frames, that is, every x·Tₓ starting from a frame having an even-numbered index, and may be performed for a maximum channel occupancy time T_{y}=0.95Tₓ. Here, it may be determined as:

$$x ∈ \{ 0 , 1 , … , \frac{20}{{T}_{x}} - 1 \} .$$

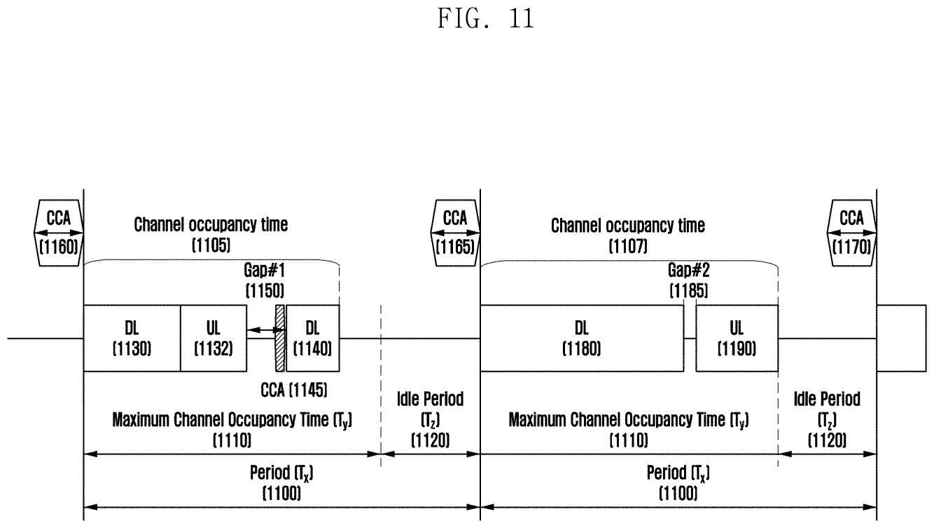

FIG. 11 illustrates an example of a channel access procedure for semi-static channel occupancy in a wireless communication system according to an embodiment of the disclosure.

Referring to FIG. 11, a periodic channel occupancy duration (or semi-static periodic channel occupancy duration, Tₓ) 1100, a channel occupancy time (COT) 1105 and 1107, maximum channel occupancy time T_{y} 1110, idle period T_{z} 1120, and clear channel assessment (CCA) duration (or sensing slot, sensing duration, or sensing slot duration) 1160, 1165, and 1170 in a base station and a terminal performing a semi-static channel access procedure are illustrated.

The base station and the terminal using the semi-static channel access procedure may perform channel sensing in a channel assessment duration 1160 or 1165, immediately before channel use or channel occupancy (e.g., DL transmission 1130 or DL transmission 1180) in order to perform assessment of whether or not the channel use (or channel occupancy) is available. Here, the sensing may be performed in at least one sensing slot duration, and the sensing slot duration (Tₑₗ) is 9 μs for example.

As an example of the sensing method, the magnitude or strength of received power detected or measured in the sensing slot duration may be compared with a predefined, configured, or calculated threshold X_{Thresh}. For example, if a result of sensing, which is performed by the base station and terminal in the channel assessment duration 1160, is smaller than X_{Thresh}, the base station and terminal may determine that the channel is in an idle state or determine that the channel use or channel occupancy is possible so as to occupy the channel and use the channel up to the maximum channel occupancy time 1110. If the sensing result is equal to or greater than X_{Thresh}, the base station and terminal may determine that the channel is in a busy state or determine that the channel use or channel occupancy is not possible, and may not use the channel until a period of time 1180 at which the next channel occupancy initiation is possible or a period of time 1165 at which channel sensing is performed in the next channel assessment duration 1165.

If the channel occupancy by a base station is initiated by performing a semi-static channel access procedure, the base station and terminal may perform communication as follows.

In one example, the base station may immediately perform DL transmission at the beginning of the channel occupancy time immediately after sensing that the sensing slot duration is in an idle state. If the sensing slot duration is sensed to be in a busy state, the base station may not perform any transmission during the current channel occupancy time.

In one example, if a gap 1150 between DL transmission 1140, which the base station wants to perform within the channel occupancy time 1105, and the previous DL transmission 1130 and UL transmission 1132 is larger than 16 μs, the base station may perform sensing for at least one sensing slot duration 1145, and may perform DL transmission 1140 or not according to a sensing result.

In one example, if a gap 1150 between the DL transmission 1140, which the base station wants to perform within the channel occupancy time 1105, and previously performed UL transmission 1132 of the terminal is at most 16 μs (or equal to or smaller than 16 μs), the base station may perform DL transmission 1140 without channel sensing (without the sensing slot duration 1145).

In one example, in a case where the terminal performs UL transmission 1190 within a channel occupancy time 1107 of the base station, if a gap 1185 between UL transmission 1190 and DL transmission 1180 is at most 16 μs (or equal to or smaller than 16 μs), the terminal may perform UL transmission 1190 without channel sensing.

In one example, in a case where the terminal performs UL transmission within the channel occupancy time 1107 of the base station, if a gap 1185 between the UL transmission 1190 and the DL transmission 1180 is larger than 16 μs, the terminal may perform channel sensing in at least one sensing slot duration within 25 μs duration immediately before uplink transmission 1190, and may perform UL transmission 1190 or not according to a sensing result.

In one example, the base station and the terminal may not perform any transmission in a set of consecutive symbols of at least T_{z}=max (0.05 Tₓ, 100 μs) duration before the beginning of the next channel occupancy time.

Hereinafter, a channel access procedure in a case where a channel access procedure start time of a communication device is variable or dynamic will be described. In a 5G system for performing communication in an unlicensed band, if a semi-static channel access procedure is not used or a dynamic channel access procedure is performed, a base station may perform channel sensing or channel access procedure as that of the following types.

In a 5G system for performing communication in an unlicensed band, if a semi-static channel access procedure is not used or a dynamic channel access procedure is performed, a base station may perform channel sensing or channel access procedure as that of the following types:
First type downlink channel access procedure.

According to a first type downlink channel access procedure, a base station may perform channel sensing for a predetermined time or a time corresponding to the number of sensing slots corresponding thereto before downlink transmission, and if the channel is in an idle state, the base station may perform the DL transmission. The first type downlink channel access procedure will be described in more detail as follows.

In the first type downlink channel access procedure, parameters for the first type downlink channel access procedure may be determined according to the quality of service class identifier (QCI) or 5G QoS identifier (5QI) of a signal to be transmitted to a channel of an unlicensed band. Table 16 below shows an example of a relationship between a channel access priority class and QCI or 5QI. For example, QCI 1, 2, and 4 may denote QCI values for services such as conversational voice, conversational video (live streaming), and non-conversational video (buffered streaming).

If a signal for a service that does not match QCI or 5QI of Table 16 is to be transmitted in the unlicensed band, a transmitting device may select, in connection with the service, the closest QCI to the QCI or 5QI of Table 16, and select the channel access priority type therefor. In addition, if a signal to be transmitted through a channel of an unlicensed band has multiple different QCIs or 5QIs, the channel access priority class may be selected based on the QCI or 5QI having the lowest channel access priority class.

TABLE 16
Channel access priority class

| Channel | | | | | | |
|---|---|---|---|---|---|---|
| Access | | | | | | |
| Priority | | | | | | Allowed |
| class (p) | QCI or 5QI | mₚ | CW_{min.p} | CW_{max.p} | T [symbol] _{.p} | CWₚ sizes |
| 1 | 1, 3, 5, | 1 | 3 | 5 | 2 ms | {3, 7} |
| | 65, 66, 69, | | | | | |
| | 70, 79, 80, | | | | | |
| | 82, 83, 84, | | | | | |
| | 85 | | | | | |
| 2 | 2, 7, 71 | 1 | 7 | 15 | 3 ms | {7, 15} |
| 3 | 4, 6, 8, | 3 | 15 | 63 | 8 or | {15, 31, 63} |
| | 9, 72, 73, | | | | 10 ms | |
| | 74, 76 | | | | | |
| 4 | — | 7 | 15 | 1023 | 8 or | {15, 31, 63, |
| | | | | | 10 ms | 127, 255, 511, |
| | | | | | | 1023} |

[symbol]

indicates data missing or illegible when filed

If the channel access priority class value (P) is determined according to the quality of service class identifier (QCI) or 5G QoS identifier (5QI) of the signal to be transmitted to the channel of the unlicensed band, a channel access procedure may be performed using channel access procedure parameters corresponding to the determined channel access priority class value. For example, as shown in Table 16, the channel access procedure may be performed using the channel access procedure parameters corresponding to the channel access priority class value (P), such as mₚ for determining the length of a defere duration T_{d}, a set CWₚ of contention window (CW) values or sizes, and the minimum value and the maximum value (CW_{min,p}, CW_{max,p}) of the contention window. Here, after channel occupancy, the maximum available channel occupancy duration (T_{mcstp}) may also be determined according to the channel access priority class value (p).

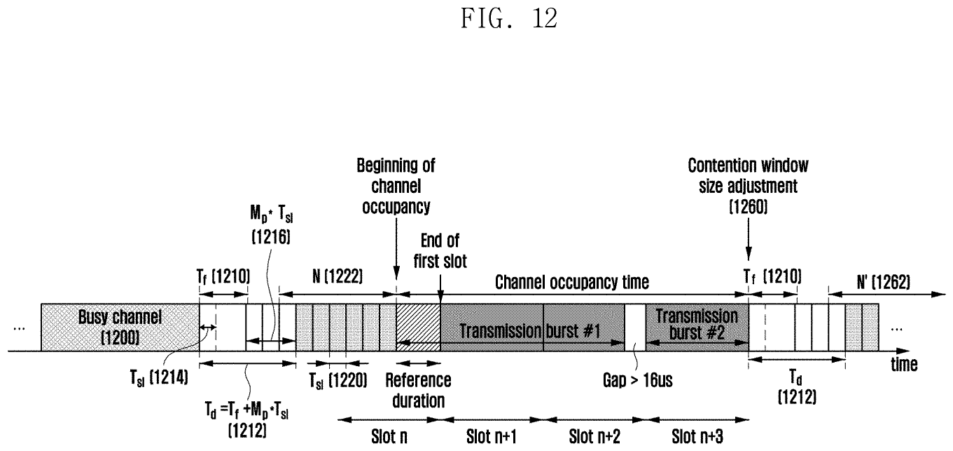

FIG. 12 illustrates an example of a channel access procedure for dynamic channel occupancy in a wireless communication system according to various embodiments of the disclosure. That is, an example of the first type downlink channel access procedure of a base station is shown.

Referring to FIG. 12, a base station desiring to transmit a downlink signal in an unlicensed band may perform a channel access procedure within at least delay time of T_{d} 1212. Here, the defer duration T_{d} 1212 may be sequentially configured by T_{f} 1210 and mₚ×Tₛₗ 1216. Here, T_{f} 1210 is 16 μs, and Tₛₗ 1214 and 1220 may denote the length of a sensing slot. Here, T_{f} 1210 may include one sensing slot 1214, and the sensing slot 1214 may be located at the beginning time of Tᵢ 1210. If the base station performs the channel access procedure with the channel access priority class 3 (p=3) of Table 16, the defer duration T_{d} 1212 required for performing the channel access procedure may be determined as T_{f}+mₚ×Tₛₗ. Here, it may be determined as mₚ=3. If the first Tₛₗ 1214 of T_{f} 1210 is in an idle state, the base station may not perform a channel access procedure for the remaining time (T_{f}−Tₛₗ) after the first Tₛₗ 1214 of T_{f} 1210. Here, even if the base station performs the channel access procedure for the remaining time (T_{f}−Tₛₗ), the result of the channel access procedure may not be used. In other words, the time T_{f}−Tₛₗ may denote a time for delaying the channel access procedure irrespective of the channel access procedure performed by the base station.

If it is determined that the unlicensed band is in an idle state within T_{d} 1212, the base station may start channel occupancy after N sensing slots 1222. Here, N is an integer value randomly selected using 0 and the value (CWₚ) of the contention window immediately before or at the time of starting the channel access procedure. That is, the value may be determined as N=rand(0, CWₚ). A detailed contention window configuration method will be described again below. For example, in a case of the channel access priority class p=3 of Table 16, the minimum contention window value and the maximum contention window value are 15 and 63, respectively, and the possible contention window is {15, 31, and 63}. Accordingly, the value of N may be randomly selected from one of 0 to 15, 0 to 31, or 0 to 63 according to the contention window value. The base station may perform sensing in every sensing slot, and if the strength of the received signal measured in the sensing slot is smaller than the threshold value X_{Thresh}, update of N=N−1 can be made. If the strength of the received signal measured in the sensing slot is equal to or greater than the threshold value X_{Thresh} the base station may perform channel sensing at the defer duration T_{d} while maintaining the value of N without deduction thereof. If determination as to N=0 is made, the base station may perform DL transmission. Here, the base station may occupy and use the channel for Tₘₑₒₜₚ time according to the channel access procedure class and Table 16.

In an embodiment, the contention window size adjustment 1260 may be performed after the channel occupancy time. After the contention window size adjustment 1260, a defer duration T_{d} 1212 required for performing a channel access procedure may exist again. The T_{f} time 1210 may be included in the defer duration T_{d} 1212. In addition, after N′ duration 1262, the channel access procedure may be started.

The first type of downlink channel access procedure may be divided into the following operations. The base station may sense that the channel is in an idle state during the sensing slot duration of the delay time T_{d} 1212, and may perform DL transmission if the value of counter N is 0. Here, the counter N may be adjusted according to the channel sensing performed in the additional sensing slot duration(s) according to the following operations.

Operation 1: Configure as N=Nᵢₙᵢₜ and go to operation 4. Here, Nᵢₙᵢₜ is a number randomly selected between 0 and CWₚ.

Operation 2: If N>0, the base station determines whether to decrement the counter N. If it is determined to decrement the counter, configuration of N=N=1 is made.

Operation 3: The base station senses a channel during an additional sensing slot duration. If it is determined that the channel is in the idle state, the process go to operation 4. If the channel is not in an idle state, go to operation 5.

Operation 4: If N=0, DL transmission is started, otherwise go to operation 2.

Operation 5: Channel sensing is performed until a sensing slot in a busy state is detected within the defer duration T_{d} or until all sensing slots within the defer duration T_{d} are detected as being in an idle state.

Operation 6: If it is detected that all sensing slots in the defer duration T_{d} are in an idle state, go to operation 4. If not, go to operation 5.

The procedure of maintaining or adjusting the contention window CWₚ value of the base station is as follows. Here, the contention window adjustment procedure is applied if the base station at least performs DL transmission including PDSCH corresponding to the channel access priority class p, and the procedure includes the following operations.

Operation 1: Configure as CWₚ=CWₘᵢₙₚ with regard to all the channel access priority classes p. Operation 2: In this operation 2, there may be sub-operation as shown below:
If HARQ-ACK feedback is available after the last update of CWₚ, go to operation 3.
If not, if retransmission is not included in DL transmission of the base station, transmitted after the first type channel access procedure, or the DL transmission is performed within T_{w} durtaion immediately after the reference duration of the first transmitted DL transmission burst after the first type channel access procedure after the last update of CWₚ, go to operation 5; and
In cases other than the above, go to operation 4.

Operation 3: HARQ-ACK feedback for a PDSCH transmitted in the reference duration of the most recent DL transmission burst in which HARQ-ACK feedback for the PDSCH transmitted in the reference duration is available is used as follows. In this operation 3, there may be sub-operations as shown below:
If, among the HARQ-ACK feedback, at least one HARQ-ACK feedback among HARQ-ACK feedbacks for a PDSCH transmitted in units of transport block (TB) is ACK, or if, among the HARQ-ACK feedback, at least 10% of HARQ-ACK feedback among HARQ-ACK feedbacks for a PDSCH transmitted in units of a code block group (CBG) is ACK, go to operation 1; and
If not, go to operation 4.

Operation 4: With regard to all the channel access priority classes p, CWₚ is increased to the next larger value than the current value among allowed CWₚ values. In this operation 4, there may be sub-operations as shown below:
If currently CWₚ=CWₘₐₓ₋ₚ, then CWₚ allowed as the next largest value is CW_{max,p}, and
If CWₚ=CW_{max,p} is consecutively used for K times in order to generate Nᵢₙᵢₜ, CWₚ may be initialized to CW_{min,p} with regard to the channel access priority class p. Here, K may be selected by the base station from among {1, 2, . . . , 8} with regard to each channel access priority class P.

Operation 5: Maintain CWₚ with regard to all the channel access priority classes p, and go to operation 2.

In the above, duration T_{w} is max(T_{A}, T_{B}+1 ms). Here, T_{B} is an UL/DL transmission burst duration from the start of the reference duration, and is a unit value. In a 5G system that performs communication in an unlicensed band, if the absence of other systems that share and use unlicensed band channels for a long time is guaranteed by a regulation-based method and by level of regulation, T_{A}=5 ms, and if not, T_{A}=10 ms.

In an embodiment, a reference duration may denote a duration which comes first in time among: a duration which is obtained from the beginning of channel occupancy to the last of the first slot during channel occupancy including PDSCH transmission of the base station, and includes at least one unicast PDSCH transmitted through all of the time-frequency resource regions allocated to the PDSCH; or a duration which is obtained from the start of channel occupancy to the end of a DL transmission burst, and includes at least one unicast PDSCH transmitted through all of the time-frequency resource regions allocated to the PDSCH. If the unicast PDSCH is included in the channel occupancy of the base station but the unicast PDSCH transmitted through all of the time-frequency resource regions allocated to the PDSCH is not included therein, the first downlink transmission burst duration including the unicast PDSCH may be a reference duration. Here, the channel occupancy may denote transmission performed by the base station after the channel access procedure.

According to the 2A type downlink channel access procedure, the base station may perform channel sensing within at least T_{short_dl}=25 μs duration immediately before DL transmission, and may perform DL transmission if the channel is in an idle state. Here, T_{short_dl} is the length of 25 μs, and T_{f}=16 μs and one sensing slot Tₛₗ=9 μs are sequentially configured therein. Here, T_{f} includes one sensing slot and the start time of the sensing slot may be the same as the start time of T_{f}. That is, T_{f} may start with the sensing slot Tₛₗ. If the base station performs DL transmission that does not include a downlink data channel transmitted to a specific terminal, the 2A type downlink channel access procedure may be performed.

According to the 2B type downlink channel access procedure, the base station may perform channel sensing in at least T_{f}=16 μs duration immediately before downlink transmission and perform downlink transmission when the channel is in an idle state. Here, T_{f} includes one sensing slot Tₛₗ=9 μs, and the sensing slot may be located at the last 9 μs of T_{f}. That is, T_{f} is ended with the sensing slot Tₛₗ. The 2B type downlink channel access procedure is applicable if a gap between the start of the DL transmission to be transmitted by the base station and the end of UL transmission of the terminal is equal to or less than 16 μs.

The 2C type downlink channel access procedure is applicable if a gap between the start of the DL transmission of the base station and the end of UL transmission of the terminal is equal to or less than 16 μs, and the base station may perform DL transmission without a separate procedure or channel sensing. Here, the maximum duration of DL transmission performed after the 2C type downlink channel access procedure may be 584 μs.

Here, the 2A, 2B, and 2C type downlink channel access procedures are characterized in that, unlike the first downlink channel access procedure, the channel sensing duration or time point performed by the base station before DL transmission is deterministic. Based on these characteristics, it is also possible to further classify the downlink channel access procedure as follows:
Type 1: is a type of performing DL transmission after performing a channel access procedure for a variable time, and corresponds to the first type downlink channel access procedure;
Type 2: is a type of performing DL transmission after performing a channel access procedure for a fixed time, and corresponds to the 2A type and 2B type downlink channel access procedures; and
Type 3: is a type for performing DL transmission without performing a channel access procedure, and corresponds to the 2C type downlink channel access procedure.

A base station performing a channel access procedure or channel sensing may configure an energy detection threshold or a sensing threshold X_{Thresh} as follows. Here, X_{Thresh} may be configured to have a value equal to or smaller than X_{Thresh_max} indicating the maximum energy detection threshold or sensing threshold value, and is in units of dBm.

In a 5G system that performs communication in an unlicensed band, if the absence of other systems that share and use unlicensed band channels for a long time is guaranteed by a regulation-based method and by level of regulation, it may be determined as X_{Thresh_max}=min[(Tₘₐₓ+10 dB,Xᵣ]. Here, Xᵣ is the maximum energy detection threshold required by region-specific regulation, and is in units of dBm. If the maximum energy detection threshold required by regulation is not configured or defined, it may be determined as Xᵣ=Tₘₐₓ+10 dB.

If not the above case, that is, if not the case in which the absence of other systems that share and use unlicensed band channels for a long time is guaranteed by a regulation-based method and by level of regulation in a 5G system that performs communication in an unlicensed band, the maximum energy detection threshold may be determined through Equation 1 below:

$${X}_{Thresh \_ max} = max \{ \begin{matrix}- 72 + 10 log 10 ( BWMHz \text{/} 20 MHz ) dBm , \\ min \{ \begin{matrix}{T}_{max} , \\ {T}_{max} - {T}_{A} + ( {P}_{H} + 10 log 10 ( BWMHz \text{/} 20 MHz ) - {P}_{TX}\end{matrix} \}\end{matrix} \} . \qquad [ Equation 1 ]$$

In Equation 1, T_{A} is 10 dBm at the time of transmission including PDSCH, and T_{A} is 5 dB at the time of discovery signal and channel transmission. P_{H} is 23 dBm, and F_{TX} is the maximum output power of the base station and is in units of dBm. The base station may calculate the threshold value using the maximum transmission power transmitted through one channel regardless of whether DL transmission is transmitted through one channel or multiple channels. Here, Tₘₐₓ=10 log 10(3.16228·10⁻⁸(mW/MHz)·BWMHz(MHz)) and BW is the bandwidth for one channel and is in units of MHz.

As an embodiment, a method for determining an energy detection threshold X_{Thresh} in order for the terminal to access a channel for UL transmission is as follows.

The base station may configure the maximum energy detection threshold of the terminal via higher layer signaling, for example, “maxEnergyDetectionThreshold.” A terminal that has been provided with or configured with “maxEnergyDetectionThreshold” from the base station may configure X_{Thresh_max} to be a value configured through the parameter. A terminal is not provided or not configured with “maxEnergyDetectionThreshold” from the base station may configure X_{Thresh_max} as follows. If the terminal is not provided with or does not receive an energy detection threshold offset (e.g., energyDetectionThresholdOffset provided via higher layer signaling) from the base station, the terminal may configure X_{Thresh_max} to be X′_{Thresh,max}. If the terminal is provided with or configured with an energy detection threshold offset from the base station, the terminal may configure X_{Thresh_max} to be a value which is obtained by adjusting X′_{Thresh_max} by the energy detection threshold offset. Here, X′_{Thresh_max} may be determined as follows.

In a 5G system that performs communication in an unlicensed band, if the absence of other systems that share and use unlicensed band channels for a long time is guaranteed by a regulation-based method and by level of regulation, a base station may provide higher layer signaling, for example, “absenceOfAnyOtherTechnology” to a terminal. The terminal provided or configured with “absenceOfAnyOtherTechnology” via higher layer signaling from the base station may configure X′_{Thresh_max} to be X′_{Thresh_max}=min (Tₘₐₓ+10 dB,Xᵣ) Here, Xᵣ is the maximum energy detection threshold required by region-specific regulation, and is in units of dBm. If the maximum energy detection threshold required by the regulation is not configured or defined, it may be determined as xᵣ=Tₘₐₓ+10 dB. A terminal that is not provided with or configured with “absenceOfAnyOtherTechnology” via higher layer signaling from the base station may determine X′_{Thresh_max} through Equation 1 above. Here, it may be determined as T_{A}=10 dBm; P_{H}=23 dBm, and P_{TX} is P_{CMAX_H,c}.

The channel access procedure for semi-static channel occupancy is limited to a case in which the base station initiates channel occupancy. In other words, the terminal may not perform semi-static channel occupancy and a channel access procedure therefor. The disclosure provides a method in which a terminal occupies a semi-static channel and performs a channel access procedure therefor.

A base station or cell (hereinafter, referred to as a cell or a serving cell for convenience of description) may provide a terminal, which attempts to access the cell or has accessed the cell, with information indicating whether semi-static channel occupancy by the terminal is possible. Here, the base station provides the terminal with configuration information about the semi-static channel occupancy by the terminal, so that the terminal can determine whether the semi-static channel occupancy is possible through the configuration information. Here, the base station can provide the terminal with both whether the semi-static channel occupancy by the terminal is possible and configuration information about the semi-static channel occupancy by the terminal. Here, the terminal may be provided with whether the semi-static channel occupancy is possible and/or configuration information about the semi-static channel occupancy by the terminal via at least one higher layer signal among SIB and RRC signaling from the base station. Table 17 is an example of higher layer signal information about whether the semi-static channel occupancy by the terminal is possible and configuration information (e.g., period information and offset information) about the semi-static channel occupancy by the terminal.

TABLE 17
Higher layer signal information

| channelAccessMode CHOICE { | |
|---|---|
| dynamic | NULL, |
| semiStatic | SemiStaticChannelAccessConfig |
| } | |
| SemiStaticChannelAccessConfig ::=SEQUENCE { | |
| Initiator | ENUMERATED {gNB-only, both} |
| Period_gNB | ENUMERATED {msX1, msX2, msX3.., msXn} |
| Period_UE | ENUMERATED {msY1, msY2, msY3.., msYn} |
| Offset_UE | ENUMERATED {sZ1, sZ2, sZ3.., sZn} |
| } | |

In a terminal having received the higher layer signal, if the initiator among the higher layer signal information is configured as “gNB-only,” the terminal may determine that the semi-static channel occupancy by the terminal is not possible with regard to the cell. If the higher layer signal information is configured as “both,” the terminal determines that the semi-static channel occupancy by the terminal is possible with regard to the cell, and may determine the semi-static channel occupancy time of the terminal through configuration information about the semi-static channel occupancy by the terminal, and information of Period_UE (T_{x_U}) and Offset_UE (T_{offset}). Here, the period information may be information about ms unit and the offset information may be information about a symbol unit, but the disclosure is not limited to this example and may be applied to a predetermined time unit.

Here, the offset value may be determined according to the processing time of the terminal. For example, the terminal may initiate the semi-static channel occupancy after confirming that the semi-static channel occupancy by the base station does not occur. Here, a method of determining whether the semi-static channel occupancy by the base station occurs or not may include at least one of: a method of making a determination according to whether the base station detects DL control channel transmission transmitted to the terminal, a terminal group including the terminal, or the entire cell terminal or receives the channel; a method of making a determination according to whether a DM-RS transmitted together with a downlink control channel or a downlink data channel is detected; and a method of making a determination according to whether a control signal such as SS/PBCH or CSI-RS is detected. Accordingly, the semi-static channel occupancy initiation by the terminal may be made after the minimum time required to identify whether the semi-static channel occupancy by the base station occurs or not, for example, the minimum time may be determined according to the processing time capability of the terminal.

For example, the terminal receives DCI for scheduling of the UL data channel transmission from the base station and configures, as an offset value, the minimum time required for transmission of the UL data channel according to the received DCI information, a period of time corresponding to T_{proc,2}, or the number of symbols corresponding to a period of time longer than T_{proc,2} (or the minimum number of symbols among the number of symbols corresponding to a time longer than T_{proc,2}), and thus the terminal identifies whether the semi-static channel occupancy by the base station occurs within the period of time, and may determine whether the semi-static channel occupancy initiation by the terminal is possible. If the terminal does not receive a separate offset value from the base station, the terminal may regard, as a default offset value, the number of symbols corresponding to a period of time corresponding to T_{proc,2} or a period of time longer than T_{proc,2} (or the minimum number of symbols among the number of symbols corresponding to a time longer than T_{proc,2}), and may perform configuration relating to the semi-static channel occupancy. Here, if the terminal does not receive a separate offset value from the base station, the terminal can regard 0 as a default offset value.

Here, T_{proc,2} may be expressed as follows:

T_{proc,2}=max((N₂+d_{2,1})*2048+144)·κ2^{-p}·T_{c}+Tₑₓₜ,d₂₂). [Equation 2]

Since the 5G or NR system generally performs symbol-based transmission and reception, the minimum processing time, which is required by the terminal (hereinafter, the minimum processing time of the terminal), from immediately after the last symbol of the PDCCH through which the uplink scheduling information is transmitted to immediately before a transmission start symbol (or the first symbol) of a channel or a uplink signal indicated according to the time domain resource allocation information (e.g., SLIV indicator) of scheduling DCI, can be expressed as the number of symbols (L2), and this can be expressed in the following Equation 3 below. Here, L2 may be the number of symbols from immediately after the last symbol of the PDCCH through which the uplink scheduling information is transmitted to the first uplink symbol in which the cyclic prefix (CP) starts after T_{proc,2} being calculated through Equation 2. Here, L2 and/or T_{proc,2} may be determined in consideration of the timing advance of the terminal and the influence of a time difference between multiple carriers or cells.

Here, N₂ may be a value determined according to the processing capability of the terminal and a subcarrier spacing in Tables 18 and 19. Here, μ=0, 1, 2, and 3 may be understood as subcarrier spacings of 15 kHz, 30 kHz, 60 kHz, and 120 kHz, respectively. Here, μ may be a subcarrier spacing, which is used for generation of the largest T_{proc,2} value as a result of Equation 3, among a subcarrier spacing of a PDCCH through which uplink scheduling information is transmitted and a subcarrier spacing of a PUSCH.

Tₑₓₜ is a value indicated through the scheduling DCI when performing communication in the unlicensed band, and is a value indicating the length of the extended CP or cyclic prefix extension of the transmission start symbol transmitted at a specified time of a time within the symbol immediately before the transmission start symbol (or the first symbol) of the uplink signal or channel scheduled through the time domain resource allocation information. More specifically, when performing cyclic prefix extension of the first symbol of PUSCH, SRS or PUCCH transmission, a time continuous signal sₑₓₜ^{(p,μ)}(t) in a duration t_{start,l}^{μ}−Tₑₓₜ≤t<t_{start,l}^{μ}: immediately before the first symbol l is expressed s̅ₗ^{(p,μ)}(t). Here, t<0 denotes a signal in a previous subframe or a previous slot. Tₑₓₜ of PUSCH, SRS, and PUCCH transmission scheduled by DCI is expressed as Equation 3:

Tₑₓₜ=min(max(T′ₑₓₜ,0),T_{symb,(l-1)mod7·2}_{^{μ}}^{μ}) [Equation 3]

where T′ₑₓₜ=Σₖ₌₁^{C}^{ᵢ}T_{symb,(l-k)mod7·2}_{^{μ}}^{μ}−Δᵢ.

Here, Table 18 may be referred to for Δᵢ, in a case of μ∈{0,1}, it may be determined as Cᵢ=1, and in a case of μ=2, it may be determined as C₁=2 The terminal may receive configuration of the values of C₂ and C₃ from the base station via a higher layer signal.

TABLE 18
Tₑₓₜ index for configuration

| Tₑₓₜ index i | Cᵢ | Δᵢ |
|---|---|---|
| 0 | — | — |
| 1 | C₁ | 25 · 10⁻⁶ |
| 2 | C₂ | 16 · 10⁻⁶ + T_{TA} |
| 3 | C₃ | 25 · 10⁻⁶ + T_{TA} |

If only DM-RS is transmitted in the first symbol of the uplink signal, it may be determined as d_{2,1}=0, and if not, it may be determined as d_{2,1}=1. In addition, if the uplink scheduling information indicates bandwidth part switching, d_{2,2} indicates a time required for the terminal to change the bandwidth part. If the uplink scheduling information does not indicate bandwidth part switching, it may be determined as d_{2,2}=0.

TABLE 19
PUSCH preparation time

| | PUSCH preparation |
|---|---|
| | time N2 |
| μ | [symbols] |
| 0 | 10 |
| 1 | 12 |
| 2 | 23 |
| 3 | 36 |

TABLE 20
PUSCH preparation time

| | PUSCH preparation |
|---|---|
| μ | time N2 [symbols] |
| 0 | 5 |
| 1 | 5.5 |
| 2 | 11 for frequency range 1 |

Table 19 described above indicates N₂ value provided in UE capability 1, and Table 20 is N₂ value provided in UE capability 2. A UE supporting capability 2 may be configured to apply a processing time of one of Tables 19 to 20 through a higher layer signal. For example, if processingType2Enabled of PUSCH-ServingCellConfig in a higher layer signal message is configured (enabled), the UE applies processing time according to the N₂ value provided in UE capability 2 as shown in Table 20. Otherwise, the UE applies processing time according to the N₂ value provided in UE capability 1 of Table 19. Here, κ and T_{c} may be defined as in Equation 4:

T_{c}=1/(Δfₘₐₓ·N_{f})Δfₘₐₓ=480·10³ Hz,N_{f}=4096,κ=Tₛ/T_{c}=64,T_{B}=1/(Δf_{ref}·N_{f,ref}), [Equation 4]

Δf_{ref}=15·10³ Hz,N_{f,ref}=2048

In other words, if the number of symbols, at the interval from immediately after the last symbol of the PDCCH through which uplink scheduling information is transmitted to a transmission slot (K2) of the channel or the uplink signal indicated according to at least time domain resource allocation information among the scheduling information and transmission start symbols (or the first symbols) in the transmission slot, is at least L2 symbol or more, the terminal may perform scheduled PUSCH transmission. If the number of symbols, at the interval from immediately after the last symbol of the PDCCH through which uplink scheduling information is transmitted to the transmission start symbols (or the first symbols) of the channel or the uplink signal indicated according to at least time domain resource allocation information among the scheduling information, is smaller than L2 symbol, the terminal may ignore uplink scheduling information and not perform PUSCH transmission.

Accordingly, the terminal receives DCI for scheduling of the UL data channel transmission from the base station and configures, as an offset value, the minimum time required for transmission of the UL data channel according to the received DCI information, a time corresponding to T_{proc2}, or the number of symbols corresponding to a time longer than T_{proc2} (or the minimum number of symbols among the number of symbols corresponding to a time longer than T_{proc2}), and thus the terminal may identify whether the semi-static channel occupancy by the base station occurs within the time and determine whether the semi-static channel occupancy initiation by the terminal is possible.

The terminal, having received the configuration information about the semi-static channel occupancy by the terminal from the base station, may determine the semi-static channel occupancy time of the terminal by applying the offset value and the period value based on at least one reference time among the following reference times. For example,
The terminal considers, as a reference time, a specific system frame number (SFN), for example, one of SFN 0 or even-numbered SFN, or
The terminal considers, as a reference time, start symbol or one semi-static channel occupancy start time among the semi-static channel occupancy times of the base station (for example, if periodic channel occupancy by the base station is initiated every x·Tₓ among two consecutive frames, the terminal considers, as the reference time, the start time or the start symbol of x·Tₓ)

The semi-static channel occupancy time of the terminal may be determined by applying the offset value and the period value. If the offset value is not configured in the above, the terminal may determine the semi-static channel occupancy time of the terminal in the same manner as the case where the offset value is 0 above. The above case is the same as the case where the default value of the offset is 0.

Here, the terminal may receive multiple pieces of semi-static channel occupancy configuration information from the base station through a higher layer signal. If receiving multiple pieces of semi-static channel occupancy configuration information, the terminal may be provided with an identifier for distinguishing each pieces of semi-static channel occupancy configuration information. Here, the identifier is only an example, and may be information indicating one of information corresponding to or related to each piece of semi-static channel occupancy configuration information (e.g., index, identifier, or ID, etc.), and the static channel occupancy configuration information may be distinguished through the above information.

The terminal provided with multiple pieces of semi-static channel occupancy configuration information may use one of the multiple pieces of semi-static channel occupancy configuration information according to the following method. For example,
The terminal randomly selects one of the configured semi-static channel occupancy configuration information or selects one of the most suitable semi-static channel occupancy configuration information for the terminal to effectively perform communication based on information such as QoS, or
The terminal may be instructed or activated from the base station to use one semi-static channel occupancy configuration information through a separate higher layer signal or information included in MAC CE or DCI.

If the terminal selects one of multiple pieces of semi-static channel occupancy configuration information, the terminal may provide or transmit an identifier for the selected semi-static channel occupancy configuration information to the base station by using at least one of uplink control information (UCI) and MAC CE. If the terminal has been instructed or activated from the base station to use one of multiple pieces of semi-static channel occupancy configuration information through the MAC CE information, the terminal may transmit MAC CE information confirming that the MAC CE information has been correctly received (confirmation MAC CE) or HARQ-ACK information (or ACK information) (with regard to PDSCH including the MAC CE for example) to the base station.

Meanwhile, the terminal may change the semi-static channel occupancy configuration information after a period of time defined in advance or configured through a higher layer signal. For example, in a case where the terminal selects one of multiple pieces of semi-static channel occupancy configuration information, the terminal may apply new channel occupancy configuration information after at least X time (for example, 200 ms) after application of the pre-selected channel occupancy configuration information. This X time is predetermined or may be configured by the base station.

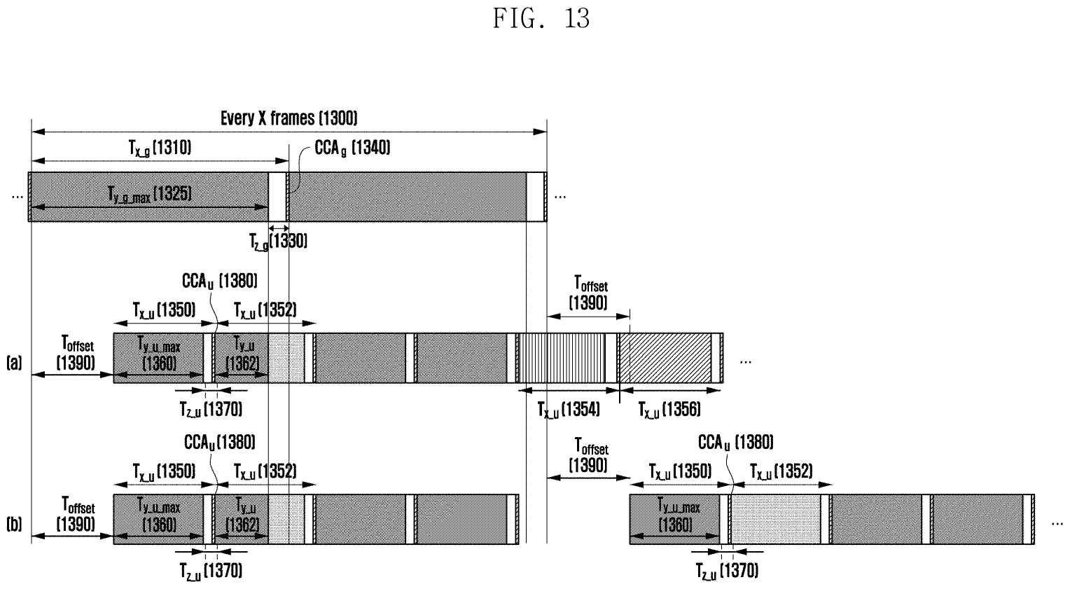

FIG. 13 illustrates an example of a configuration for semi-static channel occupancy of a terminal in a wireless communication system according to various embodiments of the present disclosure. A semi-static periodic channel occupancy duration, a semi-static channel occupancy time, a maximum channel occupancy time, an idle period, a channel assessment duration, and the like of a base station and a terminal will be described with reference to FIG. 13.

Referring to FIG. 13, a periodic channel occupancy duration T_{x_g} 1310, a channel occupancy time (COT) T_{y_g}, a maximum channel occupancy time T_{y_g,ax} 1325, an idle period T_{z_g} 1330, a clear channel assessment (CCA) duration (or sensing slot or sensing duration) 1340 of a base station that performs semi-static channel access procedure, and a periodic channel occupancy duration (hereinafter, semi-static periodic channel occupancy time T_{x_u}) 1350, a channel occupancy time (COT) T_{y_u} 1362, a maximum channel occupancy time 1360, an idle period T_{z_u} 1370, a clear channel assessment (CCA) duration (or sensing slot or sensing duration) 1380, and offset (T_{offset}) 1390 of a terminal that performs semi-static channel access procedure are illustrated. FIG. 13 illustrates a case in which the channel occupancy times of a base station and a terminal are the same as the maximum channel occupancy time, but the channel occupancy times of a base station and a terminal may be less than the maximum channel occupancy time.

Here, the semi-static periodic channel occupancy duration of a terminal may be repeatedly configured with reference to X consecutive frames (e.g., X=2, indicated by reference numeral 1300) of the base station as shown in (b) of FIG. 13. In other words, the semi-static periodic channel occupancy duration (T_{x_u}) of the terminal may be periodically configured, with reference to the start time point or the first symbol of every X consecutive frames of the base station, from after the offset T_{offset} 1390 to the end time point or the last symbol of the X consecutive frames of the base station. Here, if the entire the semi-static periodic channel occupancy duration of the terminal is not included in X consecutive frames of the base station, the semi-static periodic channel occupancy duration may be determined to be invalid. For example, in a case of (a), the entire 5th semi-static periodic channel occupancy duration T_{x,u} 1354 of the terminal is not included in two frames 1300, and here, the 5th semi-static periodic channel occupancy duration may be determined to be invalid. Here, if the entire semi-static periodic channel occupancy duration of the terminal is not included in the X consecutive frames of the base station, the semi-static periodic channel occupancy duration may be determined to be valid only until the end time point or the last symbol of the X consecutive frames of the base station. For example, in a case of (a), the fifth semi-static periodic channel occupancy duration of the terminal may be valid up to only a duration included in the two frames 1300 or the last symbol included in the two frames 1300.

Meanwhile, if the entire semi-static periodic channel occupancy duration of the terminal is not included in the semi-static periodic channel occupancy duration of the base station, the semi-static periodic channel occupancy duration of the terminal may be determined to be invalid. For example, in a case of (a), the entire second semi-static periodic channel occupancy duration 1352 of the terminal is not included in the semi-static periodic channel occupancy duration 1310 of the base station, and here, the second semi-static periodic channel occupancy duration 1352 may be considered to be invalid. Here, if the entire semi-static periodic channel occupancy duration of the terminal is not included in the semi-static periodic channel occupancy duration of the base station, it may be determined that the semi-static channel occupancy duration of the terminal is valid up to at least one of the end time point or the last symbol of the semi-static periodic channel occupancy duration of the base station, a symbol immediately before or a time point immediately before the start of the idle period within the semi-static periodic channel occupancy duration of the base station, or a symbol immediately before or a time point immediately before the start of the channel assessment duration within the semi-static periodic channel occupancy duration of the base station. For example, in a case of (a), the second semi-static periodic channel occupancy duration of the terminal is determined to be valid up to a symbol immediately before or a time point immediately before the start of the idle period 1330 within the semi-static periodic channel occupancy duration of the base station rather than the entire second semi-static periodic channel occupancy duration 1352 of the terminal is invalid.

Here, the terminal may initiate semi-static channel access or not according to at least one of whether semi-static channel occupancy by the base station occurs, a semi-static channel occupancy periodicity, a semi-static channel occupancy time, a semi-static maximum channel occupancy time, an idle period, and a channel assessment duration. Methods for determining whether to initiate semi-static channel occupancy are described below, and a combination of at least one of the methods may be used. If it is determined that the semi-static channel occupancy is initiated, the terminal may perform one of the above-described channel access procedures or may not perform the channel access procedure as necessary.

In one embodiment of method 1, if it is determined that the semi-static channel occupancy by the base station is initiated, the terminal may determine that semi-static channel occupancy by the terminal cannot occur during at least one of a total time T_{x_g} within the semi-static periodic channel occupancy duration of the base station, and a semi-static channel occupancy time T_{y_g}, a maximum channel occupancy time (T_{y_g_max}), and an idle period (T_{z_g}) of the base station, and may not initiate the semi-static channel occupancy.

Method 1 will be described with reference to (a) of FIG. 13 as an example. For example, if the semi-static periodic channel occupancy duration 1352 or semi-static channel occupancy time, configured for the terminal by the base station, overlaps with the idle period 1330 within the semi-static periodic channel occupancy duration 1310 of the base station with regard to at least one symbol, the terminal may not initiate semi-static channel occupancy in the semi-static periodic channel occupancy durations 1352 and 1354, or may determine that the semi-static periodic channel occupancy durations 1352 and 1354 are not valid. Here, the terminal may initiate the semi-static channel occupancy in the semi-static periodic channel occupancy duration 1352 and 1354, but may not perform uplink signal or channel transmission during the idle period 1330 of the base station. For example, it may be determined that the semi-static periodic channel occupancy duration 1352 of the terminal is valid (indicated by reference numeral 1362) up to only immediately before the idle period 1330 of the base station. In addition, if the start time or the first symbol of the semi-static periodic channel occupancy duration 1356 of the terminal is positioned before the offset 1390, the terminal may not initiate the semi-static channel occupancy in the semi-static periodic channel occupancy duration 1356, or may determine that the semi-static periodic channel occupancy duration 1356 is not valid.

In one embodiment of method 2, even if the terminal determines that the semi-static channel occupancy is initiated by the base station, the terminal may initiate the semi-static channel occupancy when one or a combination of the following conditions is satisfied. Similarly, the UE cannot initiate semi-static channel occupancy when one or a combination of the following conditions is not satisfied.
Condition 1: When slots and symbols not included in the indicated remaining channel occupancy during the channel occupancy duration T_{y} of the base station overlap the semi-static periodic channel occupancy duration of the terminal,
Condition 2: When slots and symbols for which the slot format is not indicated by the slot format indicator during the channel occupancy duration (T_{y}) of the base station and/or slots and symbols indicated by flexible slots or symbols (e.g., the last consecutive flexible symbols among indicated slot formats) overlap with the semi-static periodic channel occupancy duration of the terminal, or
Condition 3: Making a determination of whether to apply condition 2 according to whether or not a higher layer signal (e.g., EnableConfiguredUL) is configured.

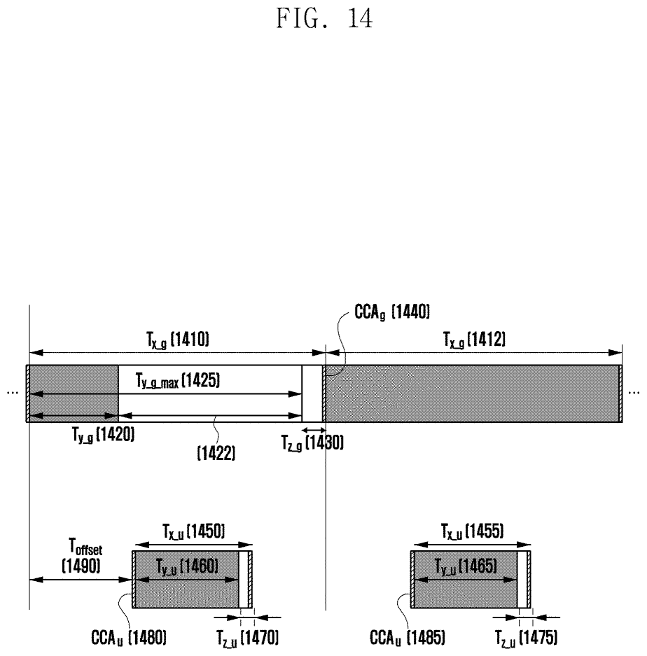

FIG. 14 illustrates an example of a method for semi-static channel occupancy by a terminal in a wireless communication system according to various embodiments of the present disclosure. Method 2 will be described with reference to FIG. 14 as follows. A terminal, having configured to include the remaining channel occupancy duration information of the base station in DCI (e.g., one of DCI transmitted commonly to a group of terminals such as DCI format 2_0 and/or DCI transmitted to a specific terminal), may determine the remaining channel occupancy duration T_{y_g} 1420 through a field indicating the remaining channel occupancy duration (e.g., channel occupancy duration information, CODuration field) of the DCI. Here, the terminal may initiate semi-static channel occupancy 1450 in at least one slot and/or symbol (that is, an unoccupied duration 1422)) that is not included in the remaining channel occupancy duration T_{y_g} 1420 indicated in a semi-static periodic channel occupancy duration T_{x_g} 1410. Here, the terminal, not configured to include the remaining channel occupancy duration information of the base station in the DCI, may determine the remaining channel occupancy duration through the slot format indicator field of the DCI. For example, the terminal may determine that a slot and/or symbol provided with the slot format through the slot format indicator field is a slot and/or symbol falls within the remaining channel occupancy duration of the base station, and may determine that a slot and/or symbol that is not provided with the slot format is a slot and/or symbol falls out of the remaining channel occupancy duration of the base station (i.e., in an unoccupied duration).

If condition 3 is described as an example, the terminal configured (or enabled) with EnableConfiguredUL (configured or enabled) may initiate the semi-static channel occupancy 1450 in at least one slot and/or symbol 1422 that is not indicated by the slot format indicator during the maximum channel occupancy duration T_{y_g} max 1425 of the base station as in condition 2 or at least one slot and/or symbol 1422 indicated or determined not to be included in the remaining channel occupancy duration. A terminal that has not been configured with EnableConfiguredUL or a terminal that is disabled with EnableConfiguredUL may not initiate the semi-static channel occupancy in at least one slot and/or symbol 1422 that is not indicated by the slot format indicator during the maximum channel occupancy duration T_{y_g} of the base station or at least one slot and/or symbol 1422 indicated or determined not to be included in the remaining channel occupancy duration.

In one embodiment of method 3, a base station provides a method for initiating semi-static channel occupancy to a terminal through a higher layer signal and/or DCI, and the terminal initiates semi-static channel occupancy according to the configuration of the DCI and/or the higher layer signal.

For example, the base station may configure the terminal to perform semi-static channel occupancy initiation according to one of method 1 and method 2 through a higher layer signal (e.g., EnableUEinitiatedCO). The terminal configured with the higher layer signal may perform semi-static channel occupancy initiation according to the configuration (e.g., if EnableUEinitiatedCO is configured) or may not perform semi-static channel occupancy initiation (e.g., if EnableUEinitiatedCO is not configured). In another method, the base station may indicate whether the semi-static channel occupancy initiation of the terminal is available, within the semi-static periodic channel occupancy duration of the base station, through at least one DCI among DCI transmitted to a terminal group such as DCI format 2_0 and DCI transmitted for each terminal such as DCI format 1_1.

For example, the terminal, having received an indication of whether the semi-static channel occupancy initiation of the terminal is possible through the DCI transmitted in the semi-static periodic channel occupancy duration 1410 of the base station, may determine the information about whether the semi-static channel occupancy initiation of the terminal is possible as information applied (or valid) within the semi-static periodic channel occupancy duration 1410 of the base station to which the DCI is transmitted or information applied (or valid) in a semi-static periodic channel occupancy duration 1412 next to the semi-static periodic channel occupancy duration of the base station to which the DCI is transmitted, and thus may initiate the semi-static channel occupancy or not. Here, information regarding the semi-static periodic channel occupancy duration of the base station to which the information regarding whether the semi-static channel occupancy initiation of the terminal is possible, indicated through the DCI, is applied (or valid) (for example, information regarding whether the DCI is applied in which sequential position of the semi-static periodic channel occupancy duration after the semi-static periodic channel occupancy duration of the base station from which the DCI is received) can be configured as one or multiple values through a higher layer signal.

In addition, the information regarding whether the semi-static channel occupancy initiation of the terminal is available, indicated through the DCI, may be information that is applied (or valid) from the start time point of the X-th (e.g., X=1 or the first) (or Xth valid) semi-static periodic channel occupancy duration of the base station after processing time T_{proc,2} required for the terminal to receive the DCI and obtain the information. Here, the information regarding whether the semi-static channel occupancy initiation of the terminal indicated through the DCI may be information that is applied (or valid) from the start time point of the X-th (e.g., X=1 or the first) (or Xth valid) semi-static periodic channel occupancy duration of the terminal after processing time T_{proc,2} required for the terminal to receive the DCI and obtain the information.

On the other hand, the terminal that has initiated the semi-static channel occupancy according to at least one of the above methods may not perform uplink signal or channel transmission during at least one of the idle period T_{z} of the base station and the sensing slot. If there is an uplink signal or channel being transmitted before a time corresponding to at least one of the idle period of the base station and the sensing slot, the terminal may transmit the uplink signal or channel up to immediately before the idle period of the base station or immediately before the sensing slot, and may terminate, cancel, or omit transmission of the uplink signal or channel during the idle period the base station or sensing slot.

Through at least one or a combination of the following methods, the terminal may determine whether the semi-static channel occupancy initiation of the terminal is the semi-static channel occupancy initiation within a duration for which the base station initiates the semi-static channel occupancy and occupies (e.g., the semi-static periodic channel occupancy initiation 1450 of the terminal in the semi-static periodic channel occupancy duration 1410 of the base station in FIG. 14), or is the semi-static channel occupancy in a case where the base station has not initiate the semi-static channel occupancy (e.g., the semi-static periodic channel occupancy initiation 1455 of the terminal in the semi-static periodic channel occupancy duration 1420 of the base station in FIG. 14).

In one embodiment of method A, determination is made according to the type of the configured or indicated channel access procedure.

In one embodiment of method B, determination is made according to the configured or indicated cyclic prefix extension value Tₑₓₜ.

In one embodiment of method C, determination is made according to the configured or indicated time domain resource allocation information.

In one embodiment of method D, determination is made according to a higher layer signal or an indicator value of DCI.

Method A will be described in more detail with an example as follows. A terminal, which has instructed to perform the first type uplink channel access procedure with regard to PUSCH, SRS, PUCCH, or PRACH transmission configured via a higher layer signal or scheduled through DCI from a base station, may determine that the base station does not initiate semi-static channel occupancy or the base station does not occupy a semi-static channel, and may initiate the semi-static channel occupancy (or channel sensing for semi-static channel occupancy) for PUSCH, SRS, PUCCH, or PRACH transmission. If a terminal has been configured with or instructed to perform a channel access procedure other than the first type of uplink channel access procedure, it may be determined that the semi-static channel occupancy of the terminal is made within the semi-static channel occupancy time of the base station, or that the terminal cannot initiate the semi-static channel occupancy for the uplink transmission. Here, determination made based on the first type of uplink channel access procedure is only an example, and determination as to whether the terminal performs the semi-static channel occupancy within the semi-static channel occupancy duration of the base station can be made according to one or multiple channel access procedures (e.g., a case in which the first type or the 2A type channel access procedure is instructed, and other cases).

Method B will be described in more detail with an example as follows. A terminal, which has configured or received an indication of a cyclic prefix extension value Tₑₓₜ=0 with regard to PUSCH, SRS, PUCCH, or PRACH transmission configured via a higher layer signal or scheduled through DCI from a base station, may determine that the base station does not initiate semi-static channel occupancy or that the base station does not perform the semi-static channel occupancy, and may initiate the semi-static channel occupancy for PUSCH, SRS, PUCCH, or PRACH transmission. If a terminal has configured or received an indication of a value other than Tₑₓₜ=0, it may be determined that the semi-static channel occupancy of the terminal is performed within the semi-static channel occupancy time of the base station. Here, the determination based on Tₑₓₜ=0 is only an example, and the determination can be made according to one or multiple Tₑₓₜ values (e.g., a case in which Tₑₓₜ=0 or Tₑₓₜ=2 is instructed and other cases).

Method C will be described in more detail with an example as follows. The first symbol of PUSCH, SRS, PUCCH, or PRACH transmission configured via a higher layer signal or scheduled through DCI from the base station matches the start symbol of the semi-static channel occupancy time of the terminal (or the semi-static periodic channel occupancy duration of the terminal), the terminal determines that the base station does not initiate the semi-static channel occupancy or that the base station does not occupy the semi-static channel, and may start the semi-static channel occupancy for PUSCH, SRS, PUCCH, or PRACH transmission. If the first symbol of the PUSCH, SRS, PUCCH, or PRACH transmission does not match the start symbol of the semi-static channel occupancy time of the terminal, the terminal determines that the semi-static channel occupancy of the terminal occurs within the semi-static channel occupancy time of the base station.

Method D will be described in more detail with an example as follows. For example, a base station may indicate, to a terminal, whether PUSCH, SRS, PUCCH, or PRACH transmission of the terminal is made within semi-static channel occupancy time of the base station through a higher layer signal (e.g., SharedCO) or DCI (e.g., shared channel occupancy information, SharedCOIndication field). For example, if the value of SharedCOIndication field of DCI and higher layer signal configuration (SharedCO) received by a terminal is “1,” the terminal may determine that PUSCH, SRS, PUCCH, or PRACH transmission is performed within the semi-static channel occupancy time of the base station. If the value of the field is 0, the terminal may determine that the base station does not initiate the semi-static channel occupancy or that the base station does not occupy the semi-static channel, and may initiate semi-static channel occupancy for PUSCH, SRS, PUCCH, or PRACH transmission.

The terminal, which has determined that PUSCH, SRS, PUCCH, or PRACH transmission is performed within the semi-static channel occupancy time of the base station through the above method, performs the UL transmission only immediately before the idle period within the semi-static channel occupancy duration of the base station, and does not perform the UL transmission during the idle period. Here, not performing the UL transmission may be understood as terminating, canceling, or omitting the uplink signal or channel transmission during the idle period. In addition, if the terminal performs UL transmission within the semi-static channel occupancy time of the base station, the terminal may determine whether to perform a channel access procedure. For example, if the semi-static periodic channel occupancy duration of the terminal starts within a predetermined time (for example, 16 μs) after the channel occupancy duration of the base station (or if the terminal performs UL transmission), the terminal does not perform a channel access procedure or may perform a 2C type channel access procedure. For example, if the semi-static periodic channel occupancy duration of the terminal is started after a predetermined time after the channel occupancy duration of the base station (or if the terminal performs UL transmission), the terminal may perform one of the above-described second type channel access procedure.

If the terminal has determined that the base station does not start the semi-static channel occupancy or that the base station does not occupy the semi-static channel through the above method and thus initiates the semi-static channel occupancy for PUSCH, SRS, PUCCH, or PRACH transmission, the terminal may perform the UL transmission within a channel occupancy duration within a semi-static channel occupancy periodicity of the terminal. Here, the terminal may perform one of the above-described second type channel access procedures for semi-static channel occupancy.

Here, the terminal that has initiated the semi-static channel occupancy according to at least one of the above methods may not perform uplink signal or channel transmission during at least one of the idle period (T_{z}) of the base station and the sensing slot. If there is an uplink signal or channel being transmitted before during at least one of the idle period of the base station and the sensing slot, the terminal may perform the uplink signal or channel transmission immediately before the idle period of the base station or immediately before the sensing slot, and may terminate, cancel, or omit the uplink signal or channel transmission during the idle period of the base station or the sensing slot.

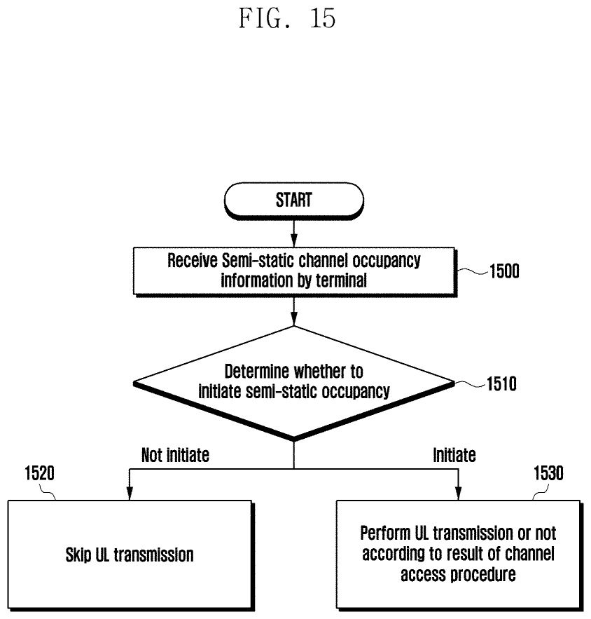

FIG. 15 illustrates an example of an operation of a terminal according to various embodiment of the present disclosure.

According to FIG. 15, a terminal may receive semi-static channel occupancy configuration information from a base station in operation 1500. The semi-static channel occupancy configuration information may include at least one of information for configuration of whether the terminal performs semi-static channel occupancy as described above and period and/or offset information, and multiple pieces of semi-static channel occupancy configuration information can be configured therein. In addition, operation 1500 may include an operation of receiving information for activation or indication of one of the multiple pieces of configuration information through a higher layer signal, MAC CE, or DCI when multiple pieces of semi-static channel occupancy configuration information are configured. The terminal determines whether to initiate the semi-static channel occupancy in operation 1510. The terminal identifies the semi-static periodic channel occupancy duration according the above-described method based on the acquired period and/or offset information, and here, the terminal may determine whether the semi-static periodic channel occupancy duration is valid or whether the semi-static channel occupancy is initiated, by using the above-described method. For example, if it is determined that the base station has initiated the semi-static channel occupancy, the terminal may determine that the semi-static channel occupancy cannot be initiated during the idle period of the base station. For example, if the entire semi-static periodic channel occupancy duration of the terminal is not included within the X frames of the base station or the semi-static periodic channel occupancy duration of the base station, the terminal may determine that the semi-static periodic channel occupancy duration is invalid and may not initiate the semi-static channel occupancy.

If it is determined that the semi-static channel occupancy is not initiated, the terminal does not perform uplink channel or signal transmission. UL transmission may be canceled or omitted. If it is determined that the terminal initiates semi-static channel occupancy, the terminal may perform a channel access procedure. The channel access procedure may be a first channel access procedure or a second channel access procedure, and may be omitted. If the channel access procedure is performed, the terminal may perform an uplink channel or signal transmission if the channel is in an idle state. Alternatively, the terminal may perform uplink channel or signal transmission without performing a channel access procedure.

Not all operations described above need to be performed in order to perform the disclosure, omission of operations, change of operation sequence, and addition of another operation may be possible.

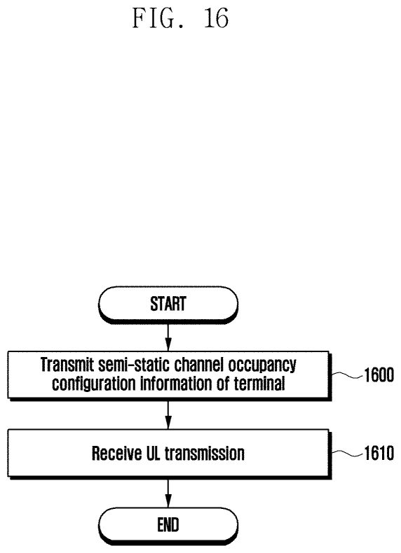

FIG. 16 illustrates an example of an operation of a base station according to various embodiments of the present disclosure.

Referring to FIG. 16, a base station may transmit semi-static channel occupancy configuration information to a terminal in operation 1600. The semi-static channel occupancy configuration information may include at least one of information for configuration of whether the terminal performs semi-static channel occupancy and period and/or offset information, and multiple pieces of semi-static channel occupancy configuration information can be configured therein. In addition, operation 1600 may include an operation of transmitting information for activation or indication of one of the multiple pieces of configuration information through a higher layer signal, MAC CE, or DCI when multiple pieces of semi-static channel occupancy configuration information are configured. Thereafter, the base station may receive an uplink channel or signal transmitted by the terminal according to the semi-static channel occupancy of the terminal. The uplink channel or signal reception may be performed in the configured semi-static periodic channel occupancy duration of the terminal.

The above-described embodiments of the disclosure are not alternatives to each other, and one or more methods may be used in combination. Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the disclosure, the term “computer program product” or “computer readable medium” is used to generally refer to a medium such as a memory, a hard disk installed in a hard disk drive, or a signal. The “computer program product” or “computer readable medium” is a means that is provided to a method for monitoring a downlink control channel in a wireless communication system according to the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure may be partially combined with any other embodiment to operate a base station and a terminal. Further, the embodiments of the disclosure may be applied to other communication systems and other variants based on the technical idea of the embodiments may be implemented. For example, the embodiments may be applied to LTE systems, 5G systems, NR systems, etc.

What is claimed is:

1. A method performed by a terminal in a communication system, the method comprising:
receiving, from a base station, configuration information for a semi-static channel occupancy performed by the terminal;
performing a channel sensing operation on an unlicensed band for the semi-static channel occupancy;
in case that the unlicensed band is idle, obtaining information indicating that a semi-static channel occupancy duration of the terminal is included in a semi-static channel occupancy duration of the base station; and
transmitting and receiving, to and from the base station, signals based on the semi-static channel occupancy duration of the terminal and the semi-static channel occupancy duration of the base station.

2. The method of claim 1, further comprising:
performing the channel sensing operation on the unlicensed band for a predetermined time duration before transmitting an uplink signal.

3. The method of claim 1, wherein the semi-static channel occupancy duration of the terminal is not overlapped with at least one of a semi-static channel occupancy time of the base station or an idle time in a semi-static channel occupancy periodicity of the base station.

4. The method of claim 1, wherein the semi-static channel occupancy duration of the terminal is started, in case that the semi-static channel occupancy duration of the terminal is overlapped with a resource that is not included in a remaining channel occupancy duration in the semi-static channel occupancy duration of the base station or a resource that is indicated as a flexible resource or that is not indicated by a slot format indicator.

5. The method of claim 1, wherein the information is received via downlink control information.

6. The method of claim 1, wherein the configuration information includes a period and an offset for the semi-static channel occupancy duration of the terminal.

7. The method of claim 6, wherein the offset for the semi-static channel occupancy duration of the terminal is associated with a processing time of the terminal.

8. A method performed by a base station in a communication system, the method comprising:
transmitting, to a terminal, configuration information for a semi-static channel occupancy performed by the terminal;
transmitting, to the terminal, information indicating that a semi-static channel occupancy duration of the terminal is included in a semi-static channel occupancy duration of the base station; and
transmitting and receiving, to and from the terminal, signals based on the semi-static channel occupancy duration of the terminal and the semi-static channel occupancy duration of the base station.

9. The method of claim 8, wherein the information is transmitted via downlink control information.

10. The method of claim 8, wherein the configuration information includes a period and an offset for the semi-static channel occupancy duration of the terminal.

11. A terminal in a communication system, the terminal comprising:
a transceiver; and
a controller coupled with the transceiver and configured to:
receive, from a base station, configuration information for a semi-static channel occupancy performed by the terminal,
perform a channel sensing operation on an unlicensed band for the semi-static channel occupancy,
in case that the unlicensed band is idle, obtain information indicating that a semi-static channel occupancy duration of the terminal is included in a semi-static channel occupancy duration of the base station, and
transmit and receive, to and from the base station, signals based on the semi-static channel occupancy duration of the terminal and the semi-static channel occupancy duration of the base station.

12. The terminal of claim 11, wherein the controller is further configured to perform the channel sensing operation on the unlicensed band for a predetermined time duration before transmitting an uplink signal.

13. The terminal of claim 11, wherein the semi-static channel occupancy duration of the terminal is not overlapped with at least one of a semi-static channel occupancy time of the base station or an idle time in a semi-static channel occupancy periodicity of the base station.

14. The terminal of claim 11, wherein the semi-static channel occupancy duration of the terminal is started, in case that the semi-static channel occupancy duration of the terminal is overlapped with a resource that is not included in a remaining channel occupancy duration in the semi-static channel occupancy duration of the base station or a resource that is indicated as a flexible resource or that is not indicated by a slot format indicator.

15. The terminal of claim 11, wherein the information is received via downlink control information.

16. The terminal of claim 11, wherein the configuration information includes a period and an offset for the semi-static channel occupancy duration of the terminal.

17. The terminal of claim 16, wherein the offset for the semi-static channel occupancy duration of the terminal is associated with a processing time of the terminal.

18. Abase station in a communication system, the base station comprising:
a transceiver; and
a controller coupled with the transceiver and configured to:
transmit, to a terminal, configuration information for a semi-static channel occupancy performed by the terminal,
transmit, to the terminal, information indicating that a semi-static channel occupancy duration of the terminal is included in a semi-static channel occupancy duration of the base station, and
transmit and receiving, to and from the terminal, signals based on the semi-static channel occupancy duration of the terminal and the semi-static channel occupancy duration of the base station.

19. The base station of claim 18, wherein the information is transmitted via downlink control information.

20. The base station of claim 18, wherein the configuration information includes a period and an offset for the semi-static channel occupancy duration of the terminal.
